(19) United States
(12) Patent Application Publication
(10) Pub. No.: US 2026/0233875 A1
(43) Pub. Date: Aug. 13, 2026

(54) HEAT-SEALABLE WEB SPLICING TAPE AND SPLICER

(71) Applicant: Pregis LLC, Chicago, IL (US)

(72) Inventors: Thomas D. Wetsch, Naples, FL (US); Sean Patrick Olsen, Chicago, IL (US)

(21) Appl. No.: 19/538,840

(22) Filed: Feb. 12, 2026

Related U.S. Application Data
(60) Provisional application No. 63/757,784, filed on Feb. 12, 2025.
(60) Provisional application No. 63/770,260, filed on Mar. 11, 2025.
(60) Provisional application No. 63/857,120, filed on Aug. 4, 2025.

(51) Int. Cl. B65B 51/28; B65H 21/00

(52) U.S. Cl. CPC B65B 51/28; B65H 21/00; B65H 2301/4621; B65H 2301/46332

(57) ABSTRACT

Splicing tapes for joining first and second webs of material include a substrate having a first and second side, each defining an opposite major surface of the substrate. The splicing tape can include a heat-activatable material located on the first side of the substrate. The heat-activatable material can be configured to form a bond upon being heated to an activation temperature. The splicing tape also can include a sealing element located on the second side of the substrate. The sealing element can be configured to affix the splicing tape to the first and second webs.

### CROSS-REFERENCE TO RELATED APPLICATIONS

This application claims the benefit under 35 U.S.C. § 119(e) of U.S. Application No. 63/757,784, filed Dec. 12, 2025; U.S. Application No. 63/770,260, filed Mar. 11, 2025; and U.S. Application No. 63/857,120, filed Aug. 4, 2025. The contents of each of these applications are incorporated by reference herein in their entireties.

### FIELD

The present disclosure relates generally to packaging and splicing techniques for packaging materials. More specifically, the present disclosure relates to a splicing tape with a heat-activatable layer.

### BACKGROUND

Envelopes and other packaging containers commonly are formed, loaded, and sealed using automated equipment such as automated bagging machines. In some applications, the bagging machine can be configured to process long, continuous sheets of stock material, such as paper or polyethylene, into a web of adjoining pre-formed envelopes. The pre-formed envelopes can be loaded, sealed closed, and separated from the web by the bagging machine. Some automated bagging machines are equipped with sealing units configured to form seals within the envelope from a heat-activatable material disposed on one or more inwardly facing surfaces of the envelope.

The sheets of stock material can be provided, for example, as rolls or fan-folded stacks. The rolls or stacks typically are spliced to other rolls or stacks so that the sheet material is supplied to the automated bagging machine on a continuous (non-interrupted) basis. For example, in applications where the sheet material is supplied in rolls, the trailing end of the expiring roll can be spliced to the leading end of the new roll to form a common interface between the new and expiring rolls.

The splices between sheets typically are formed using splicing tape. The splicing tape includes a substrate, and an adhesive deposited on the substrate and configured to adhere to the sheets. In applications where the internal seals of envelopes are formed from a heat-activatable material, the splicing tape usually needs to be placed on the surface of the sheet material that will form the exterior of the envelope. This is necessary to prevent the splicing tape from interfering with the proper formation of the heat seals within the envelope, which could occur when the splice happens to align with the sealer used to form the seals. The presence of the splicing tape on the exterior of the envelope, however, can adversely affect the aesthetic appearance of the envelope.

### SUMMARY

In one aspect of the disclosed technology, a splicing tape is configured to join a first and a second webs. The splicing tape includes a first substrate having a first side and a second side, the first and second sides each defining an opposite major surfaces of the first substrate. The splicing tape also includes a first heat-activatable material located on the first side and configured to form a bond upon being heated to an activation temperature and a sealing element located on the second side and configured to affix the splicing tape to the first and second webs.

In another aspect of the disclosed technology, the sealing element includes an adhesive configured to form a bond with the first or second webs.

In another aspect of the disclosed technology, the adhesive is a pressure-sensitive adhesive configured to form the bond upon application of a pressing force to the first side of the first substrate.

In another aspect of the disclosed technology, a splicing tape, wherein the pressure-sensitive adhesive includes at least one of: an acrylic, a rubber, and a silicone.

In another aspect of the disclosed technology, the sealing element is a layer of cohesive material configured to form the bond upon contact with a mating surface, the mating surface having a corresponding layer of the cohesive material.

In another aspect of the disclosed technology, the splicing tape further includes a release strip that includes: a second substrate having a first side and a second side, the first and second sides of the second substrate each defining an opposite major surface of the second substrate; and a release element located on the first side of the second substrate and configured to lightly bond to the adhesive so that the release strip covers and is retained on the adhesive and can be separated from the adhesive while the adhesive remains located on the first substrate.

In another aspect of the disclosed technology, the adhesive is a pressure-sensitive adhesive configured to form the bond with the first or second webs after the release strip has been removed from the pressure-sensitive adhesive and upon subsequent application of a pressing force to the first side of the first substrate.

In another aspect of the disclosed technology, the release element is a release coating applied to an entirety of the first side of the second substrate.

In another aspect of the disclosed technology, the release coating includes silicone.

In another aspect of the disclosed technology, the sealing element is configured to form a first bond upon application of first conditions to the sealing element, the heat-activatable material is configured to form a second bond upon application of second conditions to the heat-activatable material, and the heat-activatable material is configured such that the first conditions applied to the heat-activatable material are insufficient to cause the heat-activatable material to form the second bond.

In another aspect of the disclosed technology, the first conditions include a required first maximum temperature for the sealing element material to form the first bond; the second conditions include a required second minimum temperature for the heat-activatable material to form the second bond; and the heat-activatable material is configured to not form the second bond at the first maximum temperature.

In another aspect of the disclosed technology, the second minimum temperature is higher than the first maximum temperature.

In another aspect of the disclosed technology, the heat-activatable material is a heat-sealable material.

In another aspect of the disclosed technology, the heat-sealable material includes at least one of a thermoplastic, a polyolefin dispersion, an emulsion-based polymer, and a water-based polymer.

In another aspect of the disclosed technology, the heat-activatable material is a hot-melt adhesive.

In another aspect of the disclosed technology, the heat-activatable material is a reactivatable hot-melt adhesive.

In another aspect of the disclosed technology, the splicing tape further includes a region of weakness extending transversely across the splicing tape at a predetermined location in a lengthwise direction of the splicing tape, the region of weakness facilitating separation of a first portion of the splicing tape at the predetermined location.

In another aspect of the disclosed technology, the region of weakness includes perforations.

In another aspect of the disclosed technology, a spliced web includes the splicing tape, a first web made of a first sheet material and a second web made of a second sheet material. Each web includes a heat-activatable material located on a first side thereof. The heat-activatable material is configured to form a bond upon being heated to an activation temperature, and the splicing tape is affixed to the first sides of the first and second webs by the sealing element so that the second web is connected to the first web by the splicing tape.

In another aspect of the disclosed technology, the first sides of the first and second web and the first side of the first substrate define a first side of the spliced web.

In another aspect of the disclosed technology, the heat-activatable material of the first and second webs and the heat-activatable material of the splicing tape cover at least 50% of the first side of the spliced web.

In another aspect of the disclosed technology, the heat-activatable material of the first and second sheets and the heat-activatable material of the splicing tape cover at least 75% of the first side of the spliced web.

In another aspect of the disclosed technology, the heat-activatable material of the first and second webs and the heat-activatable material of the splicing tape cover an entirety of the first side of the spliced web.

In another aspect of the disclosed technology, a spliced web, wherein the heat-activatable material of the first and second webs and the heat-activatable material of the splicing tape extend continuously along the first side of the spliced web.

In another aspect of the disclosed technology, the heat-activatable material of the first and second webs and the heat-activatable material of the splicing tape extend without interruption along the first side of the spliced web.

In another aspect of the disclosed technology, the heat-activatable material of the first and second webs is interrupted by regions of discontinuity.

In another aspect of the disclosed technology, the regions of discontinuity interrupt the heat-activatable material in a repetitive pattern along lengthwise directions of the first and second webs.

In another aspect of the disclosed technology, the heat-activatable material of the first and second webs is substantially identical to the heat-activatable material of the splicing tape.

In another aspect of the disclosed technology, the activation temperature of the heat-activatable material of the first and second webs is substantially identical to the activation temperature of the heat-activatable material of the splicing tape.

In another aspect of the disclosed technology, the first and second webs each include a sheet substrate formed from paper.

In another aspect of the disclosed technology, the first substrate is formed from paper.

In another aspect of the disclosed technology, a system includes a web of supply material. The web includes a first web made of a first sheet material and a second web made of a second sheet material. Each web includes a heat-activatable material located on a first side thereof, the heat-activatable material configured to form a bond upon being heating to an activation temperature. The system also includes the splicing tape. The splicing tape is configured to connect the first web to the second web by bonding to the first sides of the first and second webs, to form a spliced web. The spliced web includes the splicing tape and the first and second webs. The system also includes a packaging machine, the packaging machine includes a sealing mechanism having two opposing sealing surfaces configured to apply sealing conditions to a sealing area on the spliced web to form a seal.

In another aspect of the disclosed technology, the sealing conditions include a sealing temperature sufficient to heat the heat-activatable material to the activation temperature.

In another aspect of the disclosed technology, the packaging machine further includes a bag mover configured to move the spliced web through the packaging machine.

In another aspect of the disclosed technology, the packaging machine further includes a folding apparatus configured to fold the spliced web about a fold line extending in a longitudinal direction of the spliced web so that a first portion of a first side of the spliced web overlies a second portion of the first side of the spliced web. The sealing mechanism is configured to form the seal between the first and second portions of the first side of the spliced web.

In another aspect of the disclosed technology, the sealing mechanism is configured to form the seal from the heat-activatable material on the splicing tape.

In another aspect of the disclosed technology, the system further includes a splicing unit having a splicing support surface configured to support the first and second webs as the first and second webs are connected by the splicing tape.

In another aspect of the disclosed technology, the splicing tape further includes a region of weakness extending transversely across the splicing tape at a predetermined location in a lengthwise direction of the splicing tape. The region of weakness facilitates separation of a first portion of the splicing tape at the predetermined location and separated by a distance about equal to a width in a widthwise direction of the first and second webs.

In one aspect of the disclosed technology, a method of splicing a first web made of a first sheet material and a second web made of a second sheet material, each web having a heat-activatable material located on a first side thereof, includes aligning the first sides of the first and the second webs in a common orientation; positioning an end portion of the second web adjacent to an end portion of the first web. The method also includes providing a splicing tape having a substrate, a sealing element located on a first side of the substrate, and a heat-activatable material located on a second side of the substrate opposite the first side. The method additionally includes applying the splicing tape to the end portions of the first and second webs so that the sealing element contacts the heat-activatable material on the end portions of the first and second webs.

In another aspect of the disclosed technology, the method further includes applying the splicing tape to the end portions of the first and second webs so that the heat-activatable material on the splicing tape and the heat-activatable material on the first and second webs extend continuously at and near a boundary between the first and second webs.

In another aspect of the disclosed technology, the method further includes applying the splicing tape onto the end portions of the first and second webs so that the sealing element on the splicing tape overlays the first sides of the first and second webs.

In another aspect of the disclosed technology, the method further includes pressing the splicing tape against the end portions of the first and second webs.

In another aspect of the disclosed technology, the method further includes abutting the end portions of the first and second webs.

In another aspect of the disclosed technology, the method further includes placing the end portion of the second web proximate the end portion of the first web so that the ends portions of the first and second webs are spaced apart by a distance less than a width of the splicing tape.

In another aspect of the disclosed technology, the method further includes overlaying the first web over the second web so that the first and second webs partially overlap and define an overlapping region; forming a cut through the overlapping region; and applying the splicing tape over the cut.

In another aspect of the disclosed technology, the method further includes removing portions of the first and second webs separated from the overlapping region by the cut.

In another aspect of the disclosed technology, the method further includes cutting the splicing tape to a length that corresponds to a width of the first or second web.

In another aspect of the disclosed technology, the method further includes removing a release strip of the splicing tape from the sealing element to expose the sealing element before applying the splicing tape onto the end portions of the first and second webs.

In another aspect of the disclosed technology, the method further includes applying the splicing tape onto the end portions of the first and second webs so that the splicing tape extends across an entire width of at least one of the first and second webs.

In another aspect of the disclosed technology, the method further includes applying first conditions to the sealing element; and subsequently applying second conditions to the heat-activatable material of the splicing tape.

In another aspect of the disclosed technology, applying the first conditions includes heating the sealing element of the splicing tape to a required first maximum temperature to form a first bond. Applying the second conditions includes heating the heat-activatable material of at least one of the first sheet material, the second sheet material, and the splicing tape to a required second minimum temperature to form a second bond, the second minimum temperature being higher than the first maximum temperature.

In one aspect of the disclosed technology, a method of forming an envelope incudes providing a web of supply material including a first web made from a first sheet material and a second web made from a second sheet of material, each web including a heat-activatable material located on a first side thereof. The method also includes applying a splicing tape having a heat-activatable material located on a side of a substrate and a sealing element located on an opposite side of the substrate to the first sides of the first and second webs by the sealing element to connect the second web to the first web by the splicing tape to form a first spliced web, the first sides of the first and second webs and the side of the substrate defining a first side of the spliced web. The method additionally includes manipulating the spliced web so that the heat-activatable material is positioned to form a seal and forming the seal by applying sealing conditions to the heat-activatable material of at least one of the first web, the second web, and the splicing tape, the sealing conditions including an activation temperature sufficient to activate the heat-activatable material.

In another aspect of the disclosed technology, the method further includes folding the first spliced web about a fold line extending in a longitudinal direction of the first spliced web so that a first portion of the first side of the first spliced web faces a second portion of the first side of the first spliced web; and forming the seal between the first and second portions of the first side of the first spliced web.

In another aspect of the disclosed technology, the method further includes forming the seal from the heat-activatable material on at least one of the first web, the second web, and the splicing tape.

In another aspect of the disclosed technology, the method further includes heating the heat-activatable material on at least one of the first web, and second web, and the splicing tape.

In another aspect of the disclosed technology, a method, further including forming the seal from the heat-activatable material on the splicing tape.

In another aspect of the disclosed technology, the method further includes aligning the splicing tape with a sealing mechanism; and heating the heat-activatable material on the splicing tape using the sealing mechanism.

In another aspect of the disclosed technology, the method further includes forming a first seal extending in a longitudinal direction of the first spliced web and a second seal extending in a transverse direction of the first spliced web.

In another aspect of the disclosed technology, the method further includes advancing the first spliced web; placing an item between the first and second portions of the first side of the first spliced web; and forming another seal between the first and second portions of the first side of the first spliced web.

In another aspect of the disclosed technology, the method further includes providing a second spliced web; overlaying the second spliced web with the first spliced web so that the first side of the first spliced web faces the first side of the second spliced web; and forming the seal between the first side of the first spliced web and the first side of the second spliced web to form a formed web.

In another aspect of the disclosed technology, the method further includes forming the seal from the heat-activatable material on at least one of the first spliced web, the second spliced web, and the splicing tape of the first spliced web.

In another aspect of the disclosed technology, the method further includes heating the heat-activatable material on at least one of the first web, the second web, and the splicing tape of the first spliced web.

In another aspect of the disclosed technology, the method further includes forming the seal from the heat-activatable material on the splicing tape of the first spliced web.

In another aspect of the disclosed technology, the method further includes aligning the splicing tape of the first spliced web with a sealing mechanism; and heating the heat-activatable material on the splicing tape of the first spliced web using the sealing mechanism.

In another aspect of the disclosed technology, the method further includes advancing the formed web; placing an item in a cavity defined between the first spliced web and the second spliced web; and forming another seal between the first spliced web and the second spliced web.

In one aspect of the disclosed technology, a bagging machine is configured to form envelopes from web material. The bagging machine includes a sealing mechanism including a sealing device having two opposing sealing surfaces configured to apply sealing conditions to a sealing area within the envelope and a splicing device. The splicing device includes a support surface configured to provide backing for a first end portion of a first web material and a second end portion of a second web material, a first restraint configured to restrain the first end portion of the first web material on the support surface, and a second restraint configured to restrain the second end portion of the second web material on the support surface independently of the first end portion of the first web material.

In another aspect of the disclosed technology, the support surface has a slot formed therein and located between the first and second restraints.

In another aspect of the disclosed technology, the splicing device further includes a cutter configured to cut the first and second end portions of the first and second web material when the first and second end portions are positioned in an overlapping arrangement on the support surface.

In another aspect of the disclosed technology, a the cutting portion is configured to be disposed, in part, within the slot.

In one aspect of the disclosed technology, a method of manufacturing splicing tape includes applying a first heat-activatable material to a side of a first substrate, the first heat-activatable material configured to form a bond upon being heated to an activation temperature. The method also includes applying a sealing element to an opposite side of the first substrate, the sealing element configured to bond to a first web and a second web, each web having a heat-activatable material located on a first side thereof.

In another aspect of the disclosed technology, the sealing element is configured to bond with the heat-activatable material on the first side of the first and second webs.

In another aspect of the disclosed technology, the method further includes applying a release strip to the sealing element, the release strip having a release element configured to lightly bond to the sealing element so that the release strip covers and is retained on the sealing element and can be separated from the sealing element while the sealing element remains located on the first substrate.

In another aspect of the disclosed technology, the method further includes applying the release element to an entirety of a side of the release strip.

In another aspect of the disclosed technology, the method further includes applying a pressure-sensitive adhesive configured to form the bond with the first or second webs upon application of a pressing force to the first side of the first substrate.

In another aspect of the disclosed technology, the method further includes applying a heat-activatable material over an entirety of the opposite side of the first substrate.

In another aspect of the disclosed technology, the method further includes applying a heat-sealable adhesive over an entirety of the side of the first substrate.

In another aspect of the disclosed technology, the method further includes applying a hot-melt adhesive over an entirety of the side of the first substrate.

In another aspect of the disclosed technology, the method further includes applying a layer of cohesive material configured to form the bond upon contact with a mating surface, the mating surface having a corresponding layer of the cohesive material.

In another aspect of the disclosed technology, the method further includes forming regions of weakness extending transversely across the splicing tape at a predetermined location in a lengthwise direction of the splicing tape, the region of weakness facilitating separation of a first portion of the splicing tape at the predetermined location.

### BRIEF DESCRIPTION OF THE DRAWINGS

The following drawings are illustrative of particular embodiments of the present disclosure and, therefore, do not limit the scope of the present disclosure. Embodiments of the present disclosure will hereinafter be described in conjunction with the appended drawings, wherein like numerals denote like elements.

FIG. 1 is a perspective view of a spliced web formed by joining ends of webs, with a splicing tape. A heat-activatable coating is located on each of the webs and the splicing tape;

FIG. 2 is a side view of a the splicing tape of FIG. 1, depicted prior to use and with a release strip covering a sealing element of the splicing tape;

FIG. 3 is a perspective view of an alternate embodiment of the spliced web of FIG. 1 depicting the heat-activatable material disposed in a repetitive pattern along a lengthwise direction;

FIG. 4 is a perspective view depicting the spliced web of FIG. 1 folded about a longitudinal centerline and sealed along overlapping longitudinal edge portions to form a formed web;

FIG. 5 is a perspective view of an alternate embodiment of the spliced web of FIG. 4 depicting two portions of the spliced web of FIG. 1 folded about two longitudinal fold lines and sealed along overlapping edge portions along the longitudinal centerline;

FIG. 6 is a front-right perspective view of a bagging machine for use with the spliced webs of FIGS. 1 and 3, depicted with certain panels and components of the bagging machine removed for clarity of illustration;

FIG. 7 is a left-rear perspective view of the bagging machine of FIG. 6 depicting the splicing tape partially applied to the ends of an expiring web and a replacement web;

FIG. 8 is a right-rear perspective view of the bagging machine of FIGS. 6 and 7, depicting the splicing tape completely applied to the ends of the expiring web and replacement web;

FIG. 9 is a top perspective view of a splicing device of the bagging machine shown in FIGS. 6-8;

FIGS. 10-14 depict a sequence by which an expiring web is spliced to a replacement web using the splicing device shown in FIG. 9, where FIG. 11 is a transverse cross-sectional view of the splicing device shown in FIG. 10, taken through line XI-XI;

FIG. 15 is a perspective view depicting two of the spliced webs shown in FIG. 1 overlaid and sealed along each overlapping longitudinal edge portion to form an alternate embodiment of the formed shown in FIG. 4;

FIG. 16 is a top view depicting a web of envelopes formed from the formed web shown in FIG. 15;

FIG. 17 is a perspective view depicting an envelope that has been loaded with an item, sealed closed, and separated from the web of envelopes shown in FIG. 16 by the bagging machine shown in FIG. 18;

FIG. 18 is a front-right perspective view of a bagging machine for use with the formed web of FIG. 15 or the web of envelopes of FIG. 16;

FIG. 19 is a flowchart depicting a method for splicing two webs together with the splicing tape shown in FIG. 2;

FIG. 20 is a flowchart depicting a method for forming an envelope using the spliced web of FIG. 1 or 3; and

FIG. 21 is a flowchart depicting a method of manufacturing the splicing tape shown in FIG. 2.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

The present disclosure relates to packaging articles and systems and methods for manufacturing the same. Packaging articles include, for example, packaging containers, protective packaging articles, and thermal insulation articles. Packaging containers can include parcel packaging and other containers to package items. Packaging containers are configured to contain and hold an item, typically enclosing the item, during shipping or storage of the item. Parcel packaging is configured for shipping and/or storing products, such as for storage in warehouse or retail shelves and displays. Examples of parcel packaging include flexible shipping containers such as envelopes, which can have varying degrees of flexibility and typically are used to ship or mail small or relatively flat items or smaller items around which the walls of the container can conform envelopes. Flexible shipping containers such as envelopes can be padded or non-padded, can be made of materials such as paper and flexible cardboard, can be configured with or without sidewalls or gussets, and can include larger envelopes such as mailers. Examples of parcel packaging also include bags, such as paper or poly bags, which can have a self-sealing capability and are typically used to ship small to medium-sized items; boxes, which can be formed from paperboard, cardboard, wood, or plastic, and typically have a rigid or semi-rigid structure suitable for holding medium to large-size items and heavier items; and shipping tubes or tube mailers, typically used to ship documents and paper items.

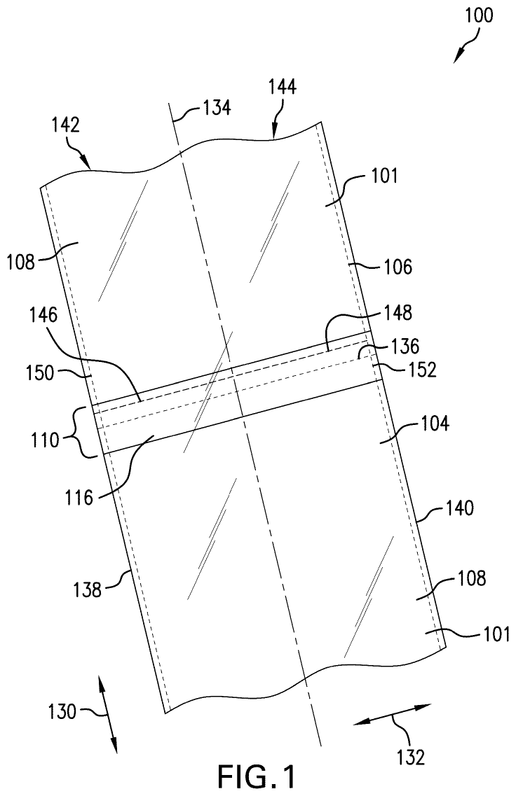

Referring to FIG. 1, a spliced web 100 includes a first web 104, a second web 106, and a splicing tape 102. The splicing tape 102 forms a splice that connects the first web 104 to the second web 106 to form a continuous spliced web 100. The first web 104 can be made of a first sheet material and the second web can be made of a second sheet material. The first and second sheet materials can be the same materials, or different materials in the alternative. For example, the first and second sheet materials can include sheet substrates formed from paper. The first and second sheet materials can be formed from a stock material in the form of regular kraft paper. The basis weight of the paper is application dependent. For example, in some applications, the paper can have a basis weight of about 20 pounds per 3,000 square feet to about 100 pounds per 3,000 square feet. The paper can have other basis weights in alternative embodiments.

The first and second webs 104, 106 can be formed from other types of paper in alternative embodiments. For example, the first and second webs 104, 106 can be formed from extensible paper, newsprint, cellulose compositions, starch compositions, and other types of paper of either virgin or recycled varieties in alternative embodiments. In other alternative embodiments, the first and second webs 104, 106 can be formed from materials other than paper, such as polyethylene, polymeric, or other synthetic materials.

Each of the webs 104, 106 includes a heat-activatable material 108 disposed on a surface thereof defined by a side 101. The heat-activatable material 108 can be applied to each side 101 of the webs 104, 106 to form a layer of the heat-activatable material 108 on each side 101. The heat-activatable material 108 can be placed on the webs 104, 106 in other suitable ways in alternative embodiments. For example, the webs 104, 106 can be impregnated with the heat-activatable material 108.

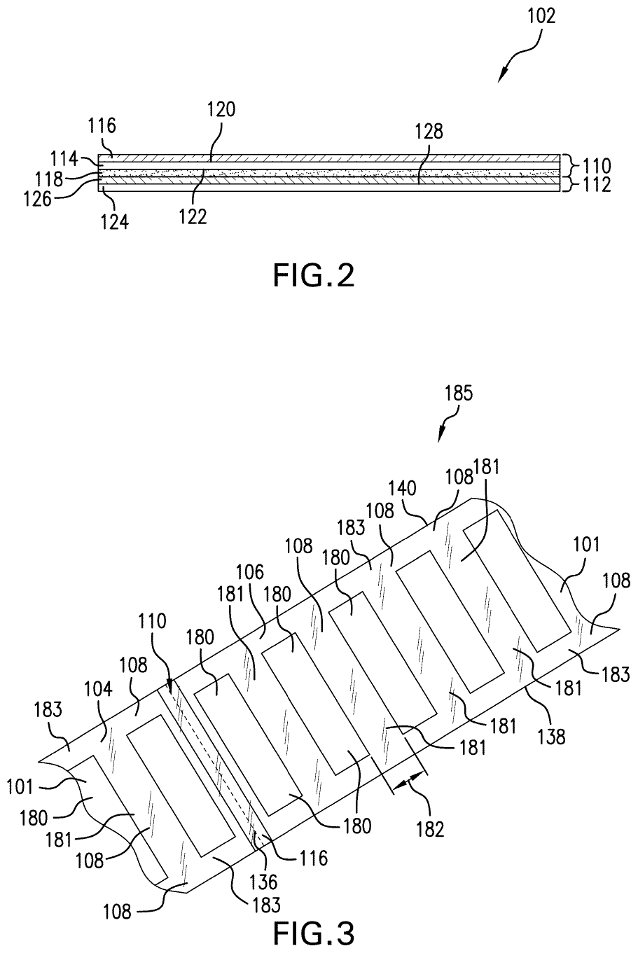

FIG. 2 is a side view of the splicing tape 102. The splicing tape 102 includes a first portion in the form of a taping member 110. The splicing tape 102 can also include a second portion in the form of a release strip 112. The taping member 110 includes a substrate 114, a heat-activatable material 116, and a sealing element 118. The heat-activatable material 116 is disposed on a side 120 of the substrate 114. The heat-activatable material 116 can be applied to the side 120 of the substrate 114 to form a layer of the heat-activatable material 116 on the side 120. The heat-activatable material 116 can be placed on the side 120 of the substrate 114 in other suitable ways in alternative embodiments. For example, the substrate 114 can be impregnated with the heat-activatable material 116. The heat-activatable material 116 is discussed in greater detail below.

The sealing element 118 is disposed on a side 122 of the substrate 114. The sealing element 118 can be applied to the side 122 of the substrate 114 to form a layer of the sealing element 118 on the side 122. The sealing element 118 can be placed on the side 122 of the substrate 114 in other suitable ways in alternative embodiments. For example, the substrate 114 can be impregnated with the sealing element 118. As can be seen in FIG. 2, the side 122 of the substrate 114 is situated opposite the side 120. The side 122 can be positioned at another suitable orientation in relation to the side 120. For example, the side 122 can be positioned adjacent the side 120 in alternative embodiments.

The sealing element 118 is configured to contact the sides 101 of the webs 104, 106 and form a bond with the heat-activatable material 108 located on the sides 101 thereby connecting the web 104 and the web 106. The bond has sufficient shear strength to maintain the taping member 110 in contact with the webs 104, 106 as the web 104 is pulled by the web 106 during processing of the spliced web 100, such as during automated manufacturing of packaging articles.

The sealing element 118 includes an adhesive material. The adhesive material can be, for example, a pressure-sensitive adhesive. The pressure sensitive adhesive can be configured to form the bond when brough into contact with a mating surface. In some embodiments, a pressing force is applied over the pressure-sensitive adhesive to form the bond. For example, the pressing force can be applied to the side 120 of the substrate 114 to activate the pressure-sensitive adhesive and form the bond. In some embodiments, the sealing element 118 can be formed from an emulsive pressure-sensitive adhesive such as acrylic. The sealing element 118 can includes other types of pressure-sensitive adhesives, and adhesives other than pressure-sensitive adhesives, in alternative embodiments.

The sealing element 118 can be formed of a cohesive material in alternative embodiments. A cohesive material includes a bonding material that causes one surface to stick to an opposing surface upon coming into contact with the same or a complimentary cohesive substance to form the bond between the two surfaces. Cohesives generally do not stick to other substances sufficiently to bond to those other substances, or in some cases stick very weakly compared to the bond they form when sticking to each other. In some embodiments, for example, the sealing member 118 is formed from a cohesive material configured to form the bond upon contact with a mating surface (not shown) having a corresponding cohesive material.

The substrate 114 of the taping member 110 is formed from a material suitable for bonding with the sealing element 118 and the heat-activable material 116; and having a tensile strength sufficient to transmit the pulling force exerted by the web 106 on the web 104 as the web 104 is pulled by the web 106 during processing of the spliced web 100 by, for example, an automated packaging machine. For example, the substrate 114 can be formed from regular kraft paper having a basis weight sufficient to meet the above-noted requirement for tensile strength. The substrate 114 can be formed from other typers of paper, and from materials other than paper, including non-cellulosic materials, in alternative embodiments. The substrate 114 is depicted in FIG. 2 as a single material. In alternative embodiments, the substrate 114 can include other suitable compositions, for example a film, a coating, a composite of materials, and/or a plurality of stacked or folded layers.

As depicted in FIG. 2, the release strip 112 initially can be disposed on the sealing element 118 of the taping member 110 so that the release strip 112 covers an entirety of the side 122 with the sealing element 118. The release strip 112 includes a substrate 124, and a release element 126 disposed on the substrate 124. The release element 126 is disposed on a side 128 of the substrate 124. The release element 126 is in contact with and covers the sealing element 118. While the release strip 112 is disposed on the taping member 110, the sealing element 118 is isolated and remains inactivated.

The release element 126 allows the release strip 112 to lightly adhere to the sealing element 118 of the taping member 110 so that the release strip 112 is retained on the taping member 110, but can be separated from the taping member 110 without damaging the sealing element 118. The sealing element 118 remains on the substrate 114 after the release strip 112 is removed. The release element 126 can be formed from a silicone or a silicone-based material. The release element 126 can be applied to the side 128 of the substrate 124 to form a layer of the release element 126 on the side 128. The release element 126 can be formed on the side 128 in other suitable ways in alternative embodiments. For example, the substrate 124 can be impregnated with the release element 126. In alternative embodiments, the release element 126 can include other suitable compositions, for example a film and/or a coating.

The substrate 124 is formed from a material suitable for bonding with the release element 126. The substrate 124 can be formed, for example, from a polypropylene material. The substrate 124 can be formed from other types of materials in alternative embodiments. The substrate is depicted in FIG. 2 as a single material. In alternative embodiments, the substrate 124 can include other suitable compositions, for example a film, a coating, a composite of materials, and/or a plurality of stacked or folded layers.

When the splicing tape 102 is to be used to make the splice between the webs 104, 106, the release strip 112 can be removed from the taping member 110 to expose the sealing element 118. The sealing element 118 is placed over and brought into contact with adjacent ends of the respective surfaces on the sides 101 of the webs 104, 106 to affix the webs 104, 106 to each other and form the spliced web 100 depicted in FIG. 1.

As noted above, the release strip 112 initially is disposed on the taping member 110 and is removed from the taping member 110 when the taping member 110 is to be applied to the webs 104, 106. In embodiments where covering and isolating the sealing element 118 is unnecessary or undesired, the release strip 112 can be omitted. The release strip 112 could be unnecessary or undesired, for example, if the sealing element 118 was formed from a cohesive material, because a cohesive material would tend not to form the bond unless brought into contact with a mating surface containing a corresponding cohesive configured to form the bond only upon contact therewith.

The heat-activatable material 108 of the webs 104, 106 and the heat-activatable material 116 of the taping member 110 can be substantially the same type of heat-activatable material so that a bond will form when substantially similar sealing conditions are applied to the webs 104, 106 and the taping member 110. The sealing conditions can include, for example, a required heat and/or pressure. In some embodiments, the sealing conditions include heating to an activation temperature. In other embodiments, the heat-activatable material 108 can differ from the heat-activatable material 116, but can be configured to form a bond at similar sealing conditions. For example, in some embodiments, although the heat-activatable materials 108, 116 may be a different type, the bond may be formed when the heat-activatable materials 108, 116 are heated to the same or a similar activation temperature.

The heat-activatable material 108 of the webs 104, 106 and/or the heat-activatable material 116 of the taping member 110 can be a heat-sealable material or a hot-melt adhesive. The following examples of heat-activable materials apply equally to the heat-activatable material 108 of the webs 104, 106 and to the heat-activatable material 116 of the taping member 110.

Hot-melt adhesives are thermoplastic polymers that are solid at room temperature, become molten when heated to an activation temperature above their softening point, and resolidify upon loss of heat at a temperature below a solidifying point, which may be the same as or different than the activation temperature, increasing in strength as they re-solidify. Most hot-melt adhesives, upon melting into a molten state and re-solidifying, do not undergo any chemical reaction such as cross-linking or removal of a carrier, e.g., evaporation of water. Thus, hot-melt adhesives typically can be reactivated, i.e., re-melted and re-solidified, after initially being applied to a substrate.

The hot-melt adhesive, after being applied to the surface to be bonded, can be in a low-tackiness state in which it has a low, or no tackiness in a lower range of temperatures. The hot-melt adhesive is reactivatable. More specifically, the hot-melt adhesive is applied hot, and cools and cures in the converting process. The hot-melt adhesive is reactivated by re-heating the hot-melt adhesive up to an activation temperature within a lower range of temperatures. This lower range of application temperatures in some embodiments, for example, is below about 140° F. In other embodiments, for example, the lower range of temperatures is below about 120° F., below about 125° F., or below about 130° F. The adhesive coating weight will affect activation temperature.

The re-heating of the hot-melt adhesive to the activation temperature causes the hot-melt adhesive to become molten. The subsequent cooling of the hot-melt adhesive, in combination with the application of pressure, causes the hot-melt adhesive to bond to the opposing surface, forming a seal between the surfaces.

A heat seal typically is formed by sealing one thermoplastic to the same or a similar thermoplastic. The thermoplastic material(s) typically is applied to the two substrates to be fixed to each other. At the time the substrates are to be fixed, the thermoplastic material(s) on one or both substrates is subject to heat and pressure sufficient to weld the materials together, thereby fixing the substrates to each other.

In some embodiments, the heat-activatable material 108 and heat-activatable material 116 can be, for example, a heat sealable materials. Heat sealable materials are pre-applied on the opposing surfaces of the substrates that are to be sealed together, typically as a coating applied to each surface. In some embodiments, the heat sealable material can be applied as a tape. The heat sealable material, after application, typically is solid in form.

An example of a heat sealable coating material is a weldable polymer provided in a thickness and with a composition such that upon applying sufficient heat to the coating and pressure to the substrates to pressure the opposing coatings against each other, the heat sealable material of the coatings melts and becomes welded together upon cooling, thereby forming a heat-seal of one substrate to the other. Typical heat sealable coatings are made of thermoplastic components. The heat sealable material on the opposing surfaces of the substrates typically is identical. In some embodiments, non-identical materials can be used in the coating provided the materials are sufficiently compatible such that the materials can melt and combine to become welded together upon cooling.

In some embodiments, the heat-sealable material can include emulsion-based polymers and polymer dispersions that dry to form heat sealable coatings. The one or more polymers can include one or more of vinyl acetate ethylene, polyvinyl acetate, polyvinyl alcohol, polyvinyl acetate copolymers, polyvinyl alcohol copolymers, dextrin stabilized polyvinyl acetate, vinyl acetate copolymers, ethylene copolymers, vinylacrylic, styrene acrylic, acrylic, styrene butyl rubber, polyurethane, polyolefins, and biodegradable materials (e.g., cellulose and starch). For example, the heat-activatable sealable material can be a polyvinyl alcohol (PVOH) coating. In some applications, the PVOH can be coated with polyethylene (PE) or polylactic acid (PLA) to prevent the PVOH from sticking, or from absorbing moisture which causes sticking.

In some embodiments, the heat-sealable material can include a polyolefin-based dispersion. The polyolefin dispersion can include polyethylene and/or polypropylene, thermoplastic polymers, polymeric stabilizing agents including at least one polar polymer, water, and/or other suitable polyolefin dispersions. A suitable polyolefin dispersion can include, for example, HYPOD™, available from Dow Chemical, or other suitable polyolefin dispersions.

In some embodiments, the heat-sealable material can be water-based. The water-based heat-sealable material may include a water-based polymer. The use of a water-based heat-sealable material can enhance the recyclability of the envelope 162, since the water-based heat-sealable material can be dissolved and separated easily from the paper pulp during the recycling process.

As another example, the heat-activatable material 108 of the webs 104, 106 and/or the heat-activatable material 116 of the taping member 110 can be an expandable material that expands when subjected to an elevated temperature. The expandable material, when expanded, can provide an additional cushioning effect to packaging containers, such as envelopes. For example, an expandable material can be provided by depositing an expansion element on to the surface of a fluid adhesive. When activated, the expansion element creates voids in the adhesive, producing a foamed adhesive. Microspheres filled with a gas, such as nitrogen, for example, can be used as the expansion element. When heated, such as by subjecting the microspheres to microwave or other radiation, the expandable material expands and can provide a cushioning effect.

Referring again to FIG. 1, the spliced web 100 formed from the webs 104, 106 and spiced together by the taping member 110 has a length extending in a longitudinal (i.e., lengthwise) direction denoted by arrow 130, and a width extending in a transverse (i.e., widthwise) direction denoted by arrow 132. The longitudinal centerline of the spliced web 100 is denoted by the reference number 134.

The heat-activatable material 108 is disposed on the respective sides 101 of the webs 104, 106 as a flood coat, i.e., the heat-activatable material 108 covers an entirety of the respective surfaces of the sides 101. The heat-activatable material 108 may extend continuously or without interruption across the webs 104, 106. In alternative embodiments, the heat-activatable material 108 can cover a majority, i.e., more that 50 percent, of the sides 101. In some embodiments, the heat-activatable material 108 can cover at least 75 percent of the sides 101 of the webs 104, 106. The heat-activatable material 116 is similarly disposed on the side 120 of the substrate 114 as a flood coat covering an entirety of the surface of the side 120.

The heat-activatable material 116 of the taping member 110 and the heat-activatable material 108 on the surfaces of the sides 101 of the webs 104, 106 forms a continuous area of heat-activable material on a major side of the spliced sheet 100. The continuous heat-activatable material can be in the form of a layer. The heat-activatable material can be activated at selective locations along the spliced web 100 by the application of sealing conditions thereto when the spliced web 100 is processed. For example, the spliced web 100 can be processed by a packaging machine to form a web of packaging material and/or a web of packaging containers, for example, envelopes. The sealing conditions can include, for example, heating to an activation temperature.

The sealing element 118 is configured to form a sealing element bond upon application of sealing element sealing conditions thereto. The heat-activatable material 116 is configured to form a heat-activatable bond upon application of heat-activatable sealing conditions thereto. The heat-activatable material 116 can be configured such that applying the sealing element sealing conditions to the heat-activatable material 116 would be insufficient to cause the heat-activatable material 116 material to form the heat-activatable bond. As previously discussed, the sealing element 118 can include an adhesive material, such as pressure-sensitive adhesive. In such an embodiment, the sealing element sealing conditions include the application of pressure. Similarly, the heat-activatable sealing conditions of the heat-activatable material 116 can include heating to an activation temperature of the heat-activatable material 116. Applying only pressure, i.e., the sealing element sealing condition in this example, to the heat-activatable material 116, without the application of heat, would generally be insufficient to cause the heat-activatable material to form the heat-activatable bond.

In alternative embodiments, the sealing element 118 can include a second heat-activatable material. The details of the second heat-activatable material are substantially identical to those discussed above in relation to the heat-activatable material 108 and heat-activatable material 116, with the following exception. When the sealing element 118 includes the second sealing material, the sealing element sealing conditions can include heating to a sealing element activation temperature. The sealing element activation temperature can differ from the activation temperature of the heat-activatable material 116. For example, the sealing element sealing conditions can include heating to a required first maximum temperature for the heat-activatable material of the sealing element 118 to form the sealing element bond. Similarly, the heat-activatable sealing conditions for the heat-activatable material 116 can include heating to a required second minimum temperature for the heat-activatable material 116 to form the heat-activatable bond. Requiring that the second minimum temperature associated with the heat-activatable sealing conditions be higher than the first maximum temperature associated with the sealing element sealing conditions allows the heat-activatable material 116 to remain deactivated while the heat-activatable material of the sealing element 118 is activated to form the sealing element bond. Two different sealing conditions for the taping member 110 having two heat-activatable materials disposed thereon can therefore be established.

Providing the second heat-activatable material for the sealing element 118 and establishing two different sealing conditions for two heat-activatable materials disposed on opposites sides 120, 122 of the taping member 110 can be advantageous for example when affixing dissimilar or composite materials. For example, a web containing paper may be joined to a web containing synthetic material. Additional, different webs containing multiple compositions of materials can be affixed to each other. In alternative embodiments, the sealing element 118 and the heat-activatable material 116 both can include heat-activatable material that has substantially identical sealing conditions.

FIG. 1 depicts an interface 136 defied by the respective ends of webs 104, 106. The interface 136 is defined by the boundary between the respective ends of the webs 104, 106 when the respective ends are aligned and positioned to form the spliced web 100. The interface 136 may also be referred to as a seam, junction, meeting point, or point of intersection of the respective ends. When the spliced web 100 is formed, the taping member 110 covers the interface 136, which is then hidden underneath the area of the spliced web 100 covered by the taping member 110.

The respective ends of the webs 104, 106 are positioned adjacent each other. As defined herein, the term adjacent encompasses at least an overlapping configuration of the respective ends of the webs 104, 106, an abutting configuration of the respective ends of the webs 104, 106, and a configuration where the respective ends of the webs 104, 106 are spaced apart by a gap. As depicted in FIG. 1, the respective ends of the webs 104, 106 can be abutted such that there is substantially no gap between the respective ends of the webs 104, 106. The interface 136 can include a gap between the respective ends of the webs 104, 106, in the alternative. The gap can be defined by a spacing between the respective ends of the webs 104, 106 extending in the longitudinal direction 130. The taping member 110 has a width that extends in the longitudinal direction 130 with respect to the spliced web 100. The taping member 110 can bridge the gap so long as the gap is narrower than the width of the taping member 110. The gap can be uniform across the interface 136, or nonuniform. A nonuniform gap can occur, for example, if the respective ends of the webs 104, 106 are not matched along the interface 136. The interface 136 is depicted as having a linear profile. The interface 136 can have a curved, angled, or otherwise non-linear profile in alternative embodiments. In other alternative embodiments, the webs 104, 106 can overlap. When the webs 104, 106 overlap, the interface 136 can be defined by the intersection between the end of one of the webs 104, 106 and the surface of the other web.

The splicing tape 102 can connect webs 104, 106 to form the spliced web sheet 100. In some applications, the web 106 can be associated with a first material supply (not shown), and the web 104 can be associated with a second material supply (not shown). The first and second material supplies can be configured to continuously supply material until depleted. Additionally, the first and second material supplies may supply substantially the same material. The first and second material supplies may supply different materials, in the alternative.

The first and/or second material supply can include a roll, stacks, or any other suitable supply of stock material. In some embodiments, the first and/or second material supply can be arranged in a fan-folded sheet configuration. In some embodiments, the splicing tape 102 is used to pre-splice material supplies. Once depleted, a new material supply may be spliced to the depleted material supply with splicing tape 102.

The web 106 may be initially drawn from the first material supply by pulling, either manually or automatically, a leading end of the material supply. The leading end of the first material supply can be an end of the first material supply that is configured to be continuously drawn from the first material supply until the first material supply is depleted. Just prior to depletion, a trailing end of the first material supply is presented. The trailing end defines the end of the web 106, which is to be spliced. Splicing to the trailing end of the first material supply permits continuity of processing as the second material supply replaces the first material supply.

The second web 104 may be drawn from the second material supply by pulling its leading end. The leading end of the second material supply defines the end of the replacement web 104 which is to be spliced to the expiring web 106, i.e., containing the trailing end of the first material supply. To prepare for splicing, the leading end of the web 104 can be positioned adjacent (i.e., overlapping, abutting, or spaced apart) the trailing end of the web 106 to form the interface 136. In some applications, the trailing end of the web 106 and the leading end of the web 104 are positioned so the ends contact or abut one another but do not overlap. In other applications, the trailing end of the web 106 and the leading end of the web104 are positioned so they overlap one another. In other applications, the trailing end of the web 106 and the leading end of the web 104 are positioned so the respective ends are in proximity to each other, without contacting or overlapping. These configurations encompass positioning one end of the web 106 adjacent with one end of the web 104. The adjacent ends of the webs 104, 106 may be spaced from one another at a distance that is less than the width of the taping member 110 in the longitudinal direction 130.

In some applications, the trailing and leading ends of the respective webs 106, 104 are positioned so that side edges 138, 140 of the web 106 align with respective side edges 138, 140 of the web 104. In other applications, the respective edges 138, 140 of the webs 104, 106 can be misaligned.

As discussed in relation to the bagging machine 300 below, in some applications, the trailing and leading ends of the respective webs 104, 106 overlap to form an overlapping region. A cut can be made through the overlapping portions of the first and second webs 106, 104, i.e., through the overlapping region. The portions that have been separated by the cut from the remainder of the respective webs 104, 106 can be removed as waste material. This cutting technique provides matched adjacent ends of the webs 104, 106 that have straight, smooth, and uniform edges that contact each other or are in very close proximity to each other. The cutting technique can mitigate defects, such as tears, wrinkles, jagged edges, etc., in the trailing and leading ends of the respective webs 104, 106 because such defects can be removed with the waste material.

The trailing and leading ends of the respective webs 104, 106 subsequently may be joined together by the taping member 110 of the slicing the 102. For example, sealing element 118 of the taping member 110 can be positioned over the interface 136 and brought into contact with the sides 101 of the webs 104, 106.

In embodiments where the sealing element 118 includes an adhesive, such as a pressure-sensitive adhesive, the release strip 112 can be included. The release strip 112 is removed from the splicing tape 102 to expose the sealing element of the taping member 110. The taping member 110 is then aligned with the interface 136 and moved toward the surfaces of the sides 101 to bring the sealing element 118 into contact with the webs 104, 106. The side 122 of the taping member 110 can then be pressed against the webs 104, 106 to activate the pressure-sensitive adhesive of the sealing element 118, thereby bonding to bond the webs 104, 106 to form the spliced web 100.

One or more aspects of the foregoing splicing process can proceed on a manual basis, or using automated equipment.

In some embodiments, the taping member 110 may extend in the transverse direction 132 across an entire width of the spliced sheet 100. The taping member 110 can be spaced from one or both of the side edges 138, 140 of the spliced web 100, in the alternative. In other alternative embodiments, a plurality of taping members 110 may be provided to completely or partially cover the interface 136.

FIG. 1 depicts the taping member 110 oriented substantially parallel with the transverse (i.e. widthwise) direction 132 of the spliced web 100. In alternative embodiments, the taping member 110 can be oriented at an angle in relation to the transverse direction 132.

When the taping member 110 is applied to the interface 136, the sealing element 118 on the side 122 of the substrate 114 faces, and contacts the surfaces defining the sides 101 of the webs 104, 106. The heat-activatable material 116 is located on the opposite the side 122 of the substrate 114. Thus, when the taping member 110 is applied, the heat-activatable material 116 is facing the same direction as the heat-activatable material 108 on the sides 101 of the web 104, 106. In this arrangement, the entirety of the surfaces of the sides 101 of the webs 104, 106 and the outwardly facing surface on the side 120 of the taping member 110 (now forming the splice between webs 104, 106), is covered by the heat-activatable material 108 and the heat-activatable material 116. In embodiments, where the heat-activatable material 108 and the heat-activatable material 116 have substantially similar sealing conditions, a continuous layer of heat-activatable material substantially covers the spliced web 100. The continuous layer of heat-activatable material permits seals to be formed at any location along the length of the spliced web 100. In applications where the spliced web 100 will be formed into a packaging container, such as an envelope, the sides 101 of the webs 104, 106 and the side 122, of the taping member 110 can be arranged to face inwardly when the packaging container is formed. In this configuration, the taping member 110, is ess likely to be visible from the outside of the envelope. Because the taping member 110 can be concealed, the aesthetic appearance of the packaging container, such as the envelope, is enhanced.

Once the webs 104, 106 have been connected by the taping member 110, the resulting spliced web 100 can be processed, for example, using automated equipment that forms various seals along the spliced web 100 to define individual web formations that can be further processed into packaging containers such as envelopes.

Referring to FIG. 3, an alternate embodiment of the spliced web 100 is depicted in the form of a spliced web 170. The above-noted description of the spliced web 100 apply equally to the respective spliced web 170 unless otherwise noted. Components of the spliced web 170 that are identical or substantially identical to those of the spliced web 100 are identified using the same reference numbers. The details of the spiced web 170 are substantially identical to those discussed in relation to the spliced web 100.

As depicted in FIG. 3, the continuous layer of heat-activatable material 108 does not cover the sides 101 of the spliced web 170. For example, the heat-activatable material 108 applied to the surfaces of the sides 101 of the webs 104, 106 include regions of discontinuity 180. The regions of discontinuity 180 can interrupt the heat-activatable material 108 at predetermined locations on the side of the web 104, the web 106, or both. For example, the heat-activatable material 108 can be applied as longitudinally-extending bands 183 and/or transversely-extending bands 181 located on webs 104, 106, and therefore on the spliced web 170. The bands 181, 183 define the locations at which seals can be formed during subsequent processing of the spliced web 170.

The bands 181, 183 also define the regions of discontinuity 180. The regions of discontinuity 180 can interrupt the heat-activatable material 108 in a repetitive pattern along the lengthwise direction of the first and second webs 104, 106. For example, the regions of discontinuity can be spaced by a distance 182 at regular intervals along the lengthwise direction of one or both of the web 104 and the web 106. The regions of discontinuity 180 can form other patterns and/or can be defined by other application characteristics of the heat-activatable material 108 to the sides 101 of the webs 104, 106, in the alternative. In other alternative embodiments, the regions of discontinuity 180 can be arranged in a nonuniform pattern.

As discussed above in relation to the spliced web 100, the spliced web 170 includes the webs 104, 106 connected by the taping member 110 of the splicing tape 102. The splicing tape 102 can be applied over the interface 136 of the webs 104, 106. The details of the splicing tape 102 and its application to the webs 104, 106 are substantially identical to those discussed above in relation to the spliced web 100. The splicing tape 102 can be applied to a region of discontinuity 180, or to area covered wholly or in part by heat-activatable material 108, for example, to a band 181. The sealing element 118 of the splicing tape 102 thus can be configured to form the bond in whole or in part with the sheet material forming the webs 104, 106. In some embodiments, the heat-activatable material 116 of the taping member 110 can form all or part of the bands 181, 183. The heat-activatable material 116 of the taping member 110 can form some or part of a repetitive pattern of the heat-activatable material 108 located on the sides 101 of the webs 104, 106, in the alternative.

The heat-activatable material 108 can be applied when each of the webs 104, 106 are being formed. Alternatively, the heat-activatable material can be applied after the webs 104, 106 have been connected by the splicing tape 102. The bands 181, 183 of heat-activatable material 108 can extend in a lengthwise direction, along respective side edges 138, 140, as can be seen in FIG. 3. The bands 181 of heat-activatable material 108 can be parallel, and extend transversely across the webs 104, 106. Each band 181 can be spaced from its adjacent band 181 by a common distance 182 so that the bands 181 are disposed in a repeating arrangement along the lengthwise direction of the webs 104, 106. FIG. 3 depicts a limited number of bands 181, 183 of the heat-activatable material 108. The depiction of only a limited number of bands 181 is intended for illustrative purposes and does not represent or limit the actual quantity of bands 181 on the spliced web 170. As discussed below, the bands 181, 183, once activated by the sealing conditions, can form seals of a packaging container, for example an envelope. Because the taping member 110 also includes the heat-activatable material 116, the taping member 110, once activated by sealing conditions, can similarly form seals on a packaging container, such as an envelope. The taping member 110 of the splicing tape 102 can therefore establish or continue the pattern of heat-activatable material 108 on the spliced web 170.

The bands 181, 183 of heat-activatable material 108 can be selectively activated at specific locations on the webs 104, 106 to form seals. The pattern defined by the regions of discontinuity 180 can correspond to certain features of a packaging article, for example an approximate height of the envelope. A packaging machine can selectively activate the heat-activatable material 108 to form packaging containers and/or to vary their size. When a supply of material in the form of the web 106 is expiring, it is therefore critical that the replacement supply of material in the form of the web 104 can be spliced without disrupting the pattern of heat-activatable material 108 associated with the webs 104, 106. The heat-activatable material 116 of the splicing tape 102 ensures that regardless of where the interface 136 occurs, the area will remain amenable to sealing.

Examples of webs 104, 106 that can be used to form the spiced web 170 include those disclosed, for example, in U.S. Patent Application Publication No. US2026/0028156 published on Jan. 29, 2026, and titled “SELECTABLE DISCRETE-LENGTH ENVELOPES,” the contents of which are incorporated by reference herein in their entirety

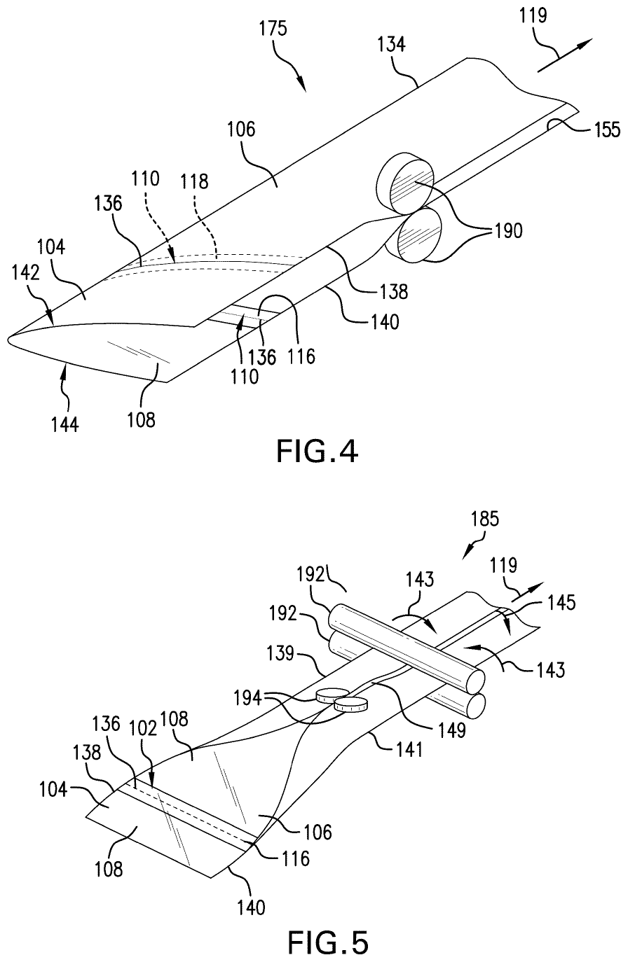

Referring to FIG. 4, the spliced web 100 (or the spliced web 170) can be folded about a longitudinal centerline 134 to form a formed web 175. A portion 142 of the spliced web 100 is folded at the longitudinal centerline 134 over a portion 144 of the spliced web 100. The heat-activatable material 108 on the webs 104, 106 and the heat-activatable material 116 on the taping member 110 overlap and align when portions 142, 144 are folded along the longitudinal centerline. The heat-activatable material 116 of the taping member 110 and the heat-activatable material 108 of the webs 104, 106 can have substantially similar sealing conditions. Thus, the spliced web 100 can be continuously sealed along edges 138, 140.

A sealing mechanism can have sealing members, such as the pair of heated rollers 190 to seal the portions 142, 144, folded about the longitudinal centerline 134 and along the edges 138, 140 to form a longitudinal seal as the spliced web 100 (or spliced web 170) advances in the processing direction, denoted by the arrow 119 in FIG. 4. The rollers 190 can apply heat to the overlapping edge portions 150, 152 (visible in FIG. 1). The heated rollers 190 can cause the heat-activatable material 108 of the webs 104, 106 and the heat-activatable material 116 of the taping member to reach their respective activation temperatures, thereby forming the bond. Because the taping member 110 includes heat-activatable material 116, the seal 155 can proceed as a continuous seal when the interface 136 is reached.

The resulting C-folded shape of the spliced web 100 (or the spliced web 170) forms the formed web 175. Transverse seals can be applied to the formed web 175 to form packaging containers of various heights. The transverse seals can be formed at any desired location if the spliced web 100 is used to form the formed web 175. The transverse seals can be formed at discrete locations of the heat-activatable material pattern if the spliced web 170 is used to form the formed web 175. Splices at the interface 136 to connect webs 104, 106 will not interfere with sealing because sealing conditions, such as heating to an activation temperature, can be applied to the heat-activatable material 116 of the splicing tape 102 for form the bond. This arrangement can be advantageous for packaging containers for bulk material. For example, packaging containers designed to hold foodstuff, such as potato chips, or granulated materials, such as fertilizer. The C-folded formed web 175 can be formed into a final configuration, loaded, sealed, and separated from the formed web 185 by a bagging machine (discussed below) or another packaging machine.

Referring to FIG. 5, the spliced web 100 (or the spliced web 170) can be folded along two longitudinal fold lines 139, 141 in a direction denoted y arrows 143 to form a formed web 185. Fold lines 139, 141 segment the spliced web into longitudinal portions. When folded, the heat-activatable material 108 on the webs 104, 106 and the heat-activatable material 116 on the taping member 110 overlap and align when the longitudinal portions are folded along the fold lines 139, 141. As discussed above in relation to the formed web 175, the heat-activatable material 116 of the taping member 110 and the heat-activatable material 108 of the webs 104, 106 can have substantially similar sealing conditions. Thus, the spliced web 100 can be continuously sealed along the edges 138, 140.

A sealing mechanism can have sealing members, such as the pair of heated rollers 194 can seal overlapping edge portions 150, 152 (visible in FIG. 1) of the spliced web 100 together as the spliced web 100 is advanced in the processing direction denoted by the arrow 119 in FIG. 5. The rollers 194 can apply heat the overlapping edge portions 150, 151. The heated rollers 194 can cause the heat-activatable material 108 of the webs 104, 106 and the heat-activatable material 116 of the taping member to reach their respective activation temperatures, thereby forming the bond. Because the taping member 110 includes the heat-activatable material 116, the seal 149 can be continuous when the interface 136 is reached.

The spliced web 100 then can be passed between two opposing rollers 192. The rollers 192 extend transversely across the width of the formed web 185. The rollers 192 flatten the overlapping end portions 150, 152 on which the seal 149 was formed. The overlapping end portions 150, 152 can be flattened onto the adjacent portion of spiced web 100, as denoted by the arrow 145 in FIG. 5. The rollers 192 also help to define the fold lines 139, 141 in the spliced web 100

The resulting double C-folded shape of the formed web 185 can be utilized in a manner similar to the formed web 175, discussed above. Transverse seals can be formed in the formed web 185 to make packaging containers of various heights. The transverse seals can be formed at any desired location if the spliced web 100 is used to form the formed web 185, and at discrete locations of the heat-activatable material pattern if the spliced web 170 is used to form the formed web 185. Splices at the interface 136 to connect webs 104, 106 will not interfere with sealing because sealing conditions, such as heating to an activation temperature, can be applied to the heat-activatable material 116 of the splicing tape 102 to form the bond. This arrangement is similar to those discussed above in relation to the formed web 175. The double C-folded formed web 185 can be formed into a final configuration, loaded, sealed, and separated from the formed web 185 by a bagging machine (discussed below) or other packaging machine.

Individual envelopes subsequently can be formed from the web 100 in a manner similar to the formation of the envelopes 162 from the web 30. The C-folded envelopes can be formed into their final configuration, loaded, sealed, and separated from the web 100 by a bagging machine or other device as discussed above in relation to the envelopes 162.

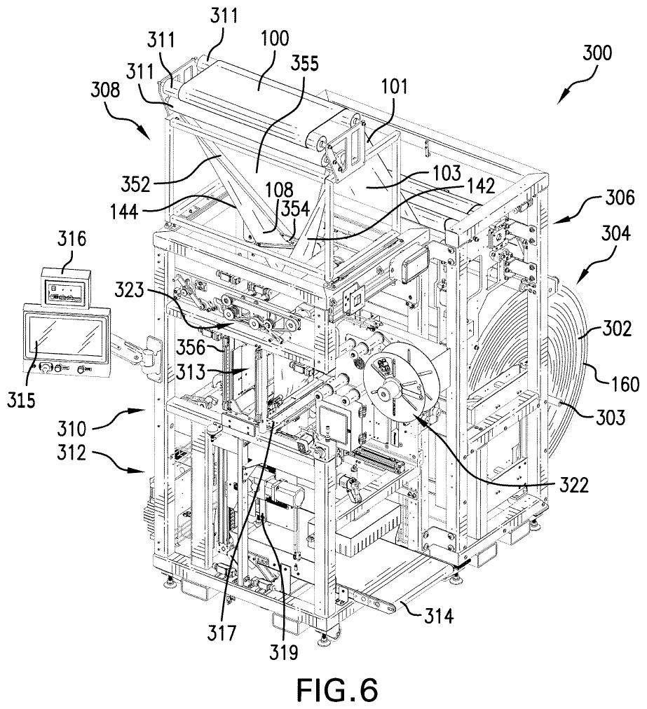

FIGS. 6-8 depict the spliced web 100 being processed into a series of front-loaded envelopes by a bagging machine 300. The bagging machine 300 is configured convert the spliced web 100 into a C-folded configuration in which the spliced web 100 is folded about the longitudinal centerline 134. In other applications, the spliced web 100 can be folded about other locations on the spliced web.

In the C-folded configuration depicted in FIGS. 6-8, a first portion 142 of the spliced web 100 overlaps a second portion 144 of the spliced web 100, with the portions 142, 144 facing each other and being located on opposite sides of the longitudinal centerline 134. The heat-activatable material 108 on the sides 101 of the webs 104, 106 and the heat-activatable material 116 on the taping member 110 are situated on the inwardly facing sides 101 of the portions 142, 144. The bagging machine 300 is configured to apply sealing conditions, for example, in the form of heat and pressure, at various locations along the portions 142, 144 folded about the longitudinal centerline 134. The sealing conditions activate the heat-activatable material 108, and the heat-activatable material 116 (when positioned of the bagging machine 300).

Sealing conditions, for example, in the form of heat and pressure, can be applied along the side edges 138, 140 at overlapping edge portions 150, 152 of the C-folded spliced web 100 in the lengthwise direction 130 to form a longitudinal seal that joins the side edges 138, 140 along the overlapping side portions 150, 152. Sealing conditions, for example in the form of heat and pressure, can be also be applied to the spiced web 100 (including the taping member 110) along the widthwise direction 132 to form transversely extending seals that locally adjoin the first and second portions 142, 144 to define individual envelopes in the sliced web 100 and form a web of envelopes. For example, a transverse seal may be formed, at least in part, by fusing line 146, which extends transversely across first portion 142 with line 148, which extends transversely across the second portion 142. Once sealed, the first portion 142 and the second portion 144 can form respective first and second walls of an envelope. Overlapping edge portions 150 and 152 can similarly be joined together

The bagging machine 300 is an example of a packaging machine that commonly uses a first material supply and second material supply, as discussed above. The first and second material supplies can be configured to continuously supply the bagging machine 300 with material until depleted. The first material supply may be an expiring roll of web material. Web 106 can be associated with a first material supply. The web 104 can be associated with a second material supply. The second material supply, as discussed above, may be a new roll of material to replace expiring roll of material in a process such as the envelope forming process performed by the bagging machine 300. The new roll of web material containing the web 104 may be spliced to the expiring roll of web material containing the web 104 using the splicing tape 102. Once spliced, the new roll of material and the expiring roll of material are made continuous and contiguous.

Once spliced, the expiring roll containing the web 106 and the new roll containing the web 104 are joined by the taping member 110 to form the spliced web 100. The length of expiring roll containing the web 106 extending in a direction denoted by arrow 130 is effectively increased by the length of the new roll containing the web 104 and extending in the same direction. Splicing of the new and expiring rolls to form the spliced web 100 allows for a smooth transition from the expiring roll to the new roll without interfering with the formation of the packaging articles, such as envelopes, by the packaging machine, such as the bagging machine 300. Additionally, because the heat-activatable material 116 of the taping member 110 is sealable, applying the splicing tape 102 to the interface 136 of the webs 104, 106 does not interfere with the ability of the bagging machine 300 to form longitudinal or transverse seals on the spiced web 100.

The following description of bagging machines 300, 400 are presented for illustrative purposes only. The spliced web 100, and alternative embodiments thereof, can be processed in other ways, by other types of automated packaging machines and by manual means. As discussed above, the bagging machine 300 is configured to convert the spliced web 100 into a C-folded configuration. An item to be packaged can be inserted into the partially formed envelope defined by the C-folded spliced web 100, and the spliced web 100 can be sealed by the bagging machine 300 to completely form the envelope with the item loaded therein.

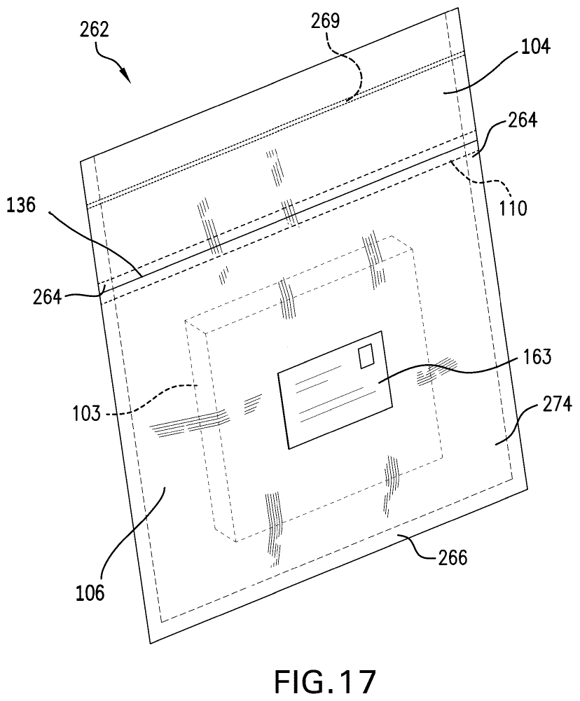

Referring to FIGS. 6-8, the bagging machine 300 is configured to seal a web 100 around one or more items 103 to be packaged (depicted in FIG. 17), to form a closed envelope 162. One, or more than one of the items 103 can be packaged in the envelope in the alternative.

The bagging machine 300 includes a supply station 304, a splicing station 326, a web advancer 305, a web accumulator 306, a folding station 308, a loading station 310, a sealing and cutting station 312, a conveyor 314, and a controller 316. The bagging machine 300 is a front-loading bagger. The components of bagging machine 300 described herein can be adapted for used in other types of bagging machines, such as top-loading baggers.

The supply station 304 accommodates the web 100 in a supply configuration of the web 100. The supply configuration can be, for example, a roll 302 of the web 100. The roll 302 can be suspended from a shaft 303 passing through the center of the roll 302 so that the roll 302 can rotate as the web 100 is drawn from the roll 302. The roll 302 can be supported in other ways in alternative embodiments. The web 100 can be provided in a supply configuration other than a roll 302 in other alternative embodiments. For example, the web 100 can be provided in a fan-folded configuration.

As discussed above, the web 100 can be formed from paper, such as regular kraft paper. The web 100 can be formed from other types of paper, including extensible paper, in the alternative. The paper can have a basis weight of, for example, 55 pounds per 3,000 square feet or 70 pounds per 3,000 square feet. Paper having other basis weights can be used in the alternative. Also, the web 100 can be formed from materials other than paper, such as polyethylene or other plastic films, in the alternative. The web 100 is configured as a single layer of sheet material. The web 100 can be formed multiple layers of sheet material in the alternative.

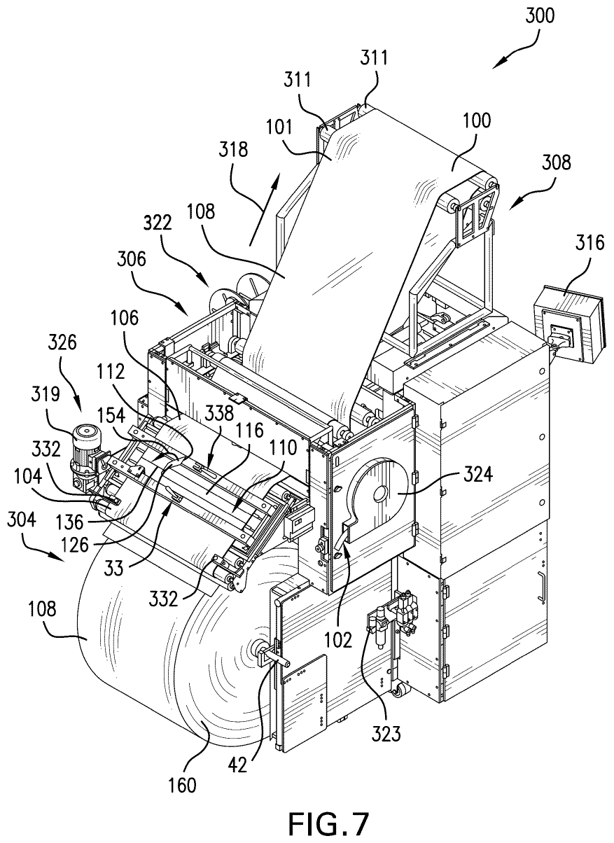

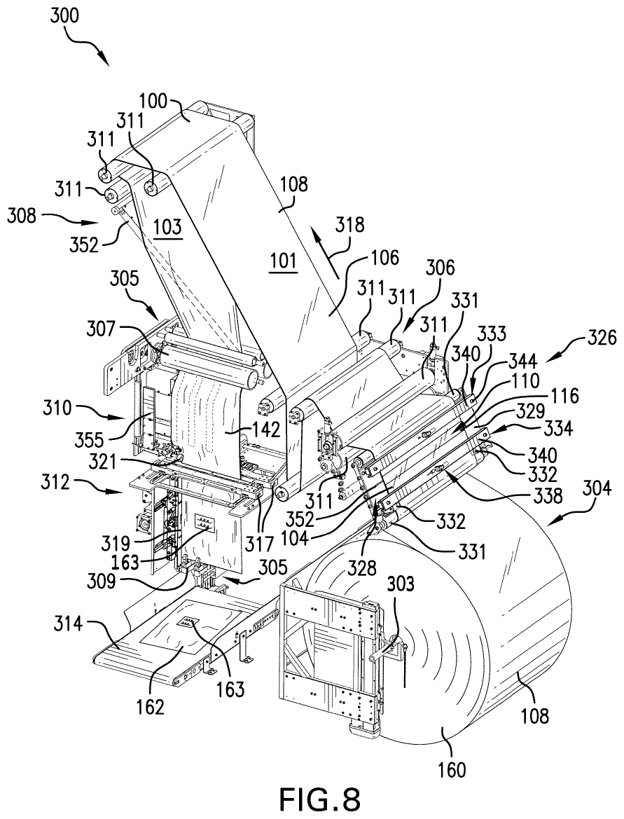

The splicing station 326 is located downstream of the supply station 304. (The terms upstream and downstream are used herein in reference to the direction of travel of the web 100 through the bagging machine 300, with the downstream direction 318 and coinciding with the direction of travel.) The splicing station 326 facilitates splicing of the trailing end of an expiring roll 353 of the web 100 to the leading end of a replacement roll 160. As the web 100 is drawn from the supply roll 302, the supply roll 302 may be spliced to another roll with the splicing tape 102, for example, when the supply roll 302 is nearing depletion or expiration. FIGS. 7 and 8 are rear perspective views of the bagging machine 300. FIG. 7 depicts the taping member 110 of the splicing tape 102 as it is being applied to the web 100, as denoted by the arrow 154. FIG. 8 depicts the taping member 110 after being applied to the web 100. The taping member 110 joins the leading end of a web 104 from a new roll 160 to the trailing end of a web 106 from an expiring roll 153 to form the spliced web 100.

The support surface 329 of the splicing device 326 is shown oriented at an angle with relative to the horizontal plane. In other embodiments, the support surface 329 and/or the splicing device 326 can be oriented at a suitable angle. For example, the splicing device 326 and/or the support surface can be oriented horizontally, vertically, or a suitable angle relative to a horizontal or vertical reference.

As also shown in FIG. 7, the bagging machine 300 also can include a dispenser 324 for storing and dispensing the splicing tape 102. The dispenser 324 is shown as a manual device; however, the dispenser can be configured to provide automatic dispensing and/or application functions. Alterative embodiments of the bagging machine 300 can be configured without the splicing station 326. Also, the splicing station 326 can be used in connection with bagging machines other than the bagging machine 300.

The web advancer 305 can include one or more drive stations configured to drive the web 100 through the bagging machine 300 in the downstream direction 318, using power transmissions 323, drive rollers, 307, guides 311, pulling devices 309, alignment devices 321, or other suitable devices to impart motion to the web 100 in the downstream direction 318. In some embodiments, the bagging machine 300 can be equipped with sensors positioned along the path of the web 100 to monitor the lateral alignment of the web 100 as it travels in the downstream direction 318.

The web accumulator 306 is located downstream of the splicing station 326. The web accumulator 306 can be located at other positions along the web path in alternative embodiments of the bagging machine 300. The web accumulator 306 helps to control the tension in the web 100. For example, the web accumulator 306 can take up slack that can form in the web 100 when the web advancer 305 is deactivated and roll 302 continues to rotate due to its angular momentum. As another example, the web accumulator 306 can help to reduce or eliminate spikes in the web tension when the web advancer 305 is activated and the web 100 begins to be pulled from the roll 302. Alterative embodiments of the bagging machine 300 can be configured without the web accumulator 306. Also, the web accumulator 306 can be used in connection with bagging machines other than the bagging machine 300.

The folding station 308 is located downstream of the splicing station 326. The folding station 308 folds the web into a C-folded configuration about a fold line coinciding generally with the longitudinal centerline 134 of the web 100, so that the portions 142, 144 of the web 100 overlap. The folding station 308 includes a folder body 360, web directors 351, and a guide fin 354 which cooperate to fold and align the web 100 about the centerline 134 and into the C-fold configuration as the web 100 moves in the downstream direction 318. Alterative embodiments of the bagging machine 300 can be configured without the folding station 308. For example, the folding station 308 is not needed in embodiments in which the web 100 is supplied in a C-folded configuration, i.e., with the C-fold already formed when the roll 302 is in its supply configuration. For example, use of the formed web 175 might not require the folding station 308. In other alternative embodiments, the web 100 can be formed by welding or otherwise connecting two separate webs along longitudinal edges thereof, with resulting seam acting as a fold line as discussed herein in relation to the C-folded web 100. Also, the folding station 308 can be used in connection with bagging machines other than the bagging machine 300. The folding station 308 can also be known as a folding apparatus.

The loading station 310 is located downstream of the folding station 308, and facilitates loading of the C-folded web 100. In particular, the loading station 310 spreads the opposing portions 142, 144 of the C-folded web 100 using arms 356 or other suitable devices to define a loading zone 313 between the sides so that an operator can place or load the item to be packaged 103 between the sides 142, 144, which at this point define the walls of the pre-formed envelope 262. In FIG. 3, the web 100 is oriented vertically and the item 103 is placed into the interior cavity in a horizontal direction, with opening to the interior cavity facing a direction transverse to the longitudinal direction 130 of the web 100. In other embodiments, the web 100 can be oriented horizontally or at another suitable angle, with the opening to the interior cavity facing upward.

The sealing and cutting station 312 is configured to seal the envelope 162 once the item 103 has been placed between the walls thereof. The sealing and cutting station 312 applies sealing conditions to the envelope by horizontal sealing members 317 to form transverse seals 266 that join the overlapping walls 274, 276 as shown in FIG. 17 and extend between the closed side of the envelope 162 defined by the fold line in the C-folded web 100, and the open side of the envelope 162 defined by the overlapping forward edges of the envelope 262. The sealing conditions applied by the vertical sealing members 319 of sealing and cutting station 312 also form a vertical seal that joins the overlapping forward edges of the envelope 162.

The sealing and cutting station 312 also separates the envelope 162 from the web 100 after the sealing process. The sealing and cutting station 312 can separate the envelope 162 by cutting, shearing, tearing, the focused application of heat, etc. In some embodiments, the bagging machine 300 can include a separating mechanism configured to separate the envelope 162 from the web 100. The separating mechanism can be configured to pull on the completed envelope 162, tearing the completed envelope 162 from a subsequent bag along a region of weakness. In alternative embodiments, the separating mechanism can be configured to separate the envelope 162 using a blade or by the application of heat. In other alternative embodiments, the separating mechanism can incorporate other devices for separating the envelopes 162. In some embodiments, the separating mechanism can be configured to hold the envelope 162 in place to enable the sealing mechanism to seal a subsequent envelope 162.

The heat-activatable material 116 of the taping member 110 faces inward within the C-folded web 100. In this configuration, the heat-activatable material 116 on the side 120 of the taping member 110 on the first portion 142 of the web 100 faces the heat-activatable material 116 on the side 120 of the taping member 110 on the second portion 142 of the web 100. The heat-activatable material 108 on the sides 101 of the webs 104, 106 are also facing each other when the portions 142, 144 of the web 100 are folded about the longitudinal centerline 134. Thus, the inwardly facing sides 101 of the first and second portions 142, 144 of the C-folded web 100 are covered in their entirety by the heat-activatable material 108 and the heat-activatable material 116. The horizontal sealing members 317 and the vertical sealing members 319 thus can form the longitudinally extending seals and the transversely extending seals at any location along the web 100, including on the splices formed by the taping members 110, which occurs when the splices align with the sealing members 317, 319.

The sealed envelopes 162 can drop or otherwise become disposed on the conveyor 314 after being separated from the web 100. The conveyor 314 can transport the envelopes 162 to a shipping area or other location. Alternative embodiments of the bagging machine 300 can be configured without the conveyor 314. In such embodiments, for example, the sealed envelopes 162 can be collected in a stationary bin or other device after being separated from the web 12.

The bagging machine 300 also includes an input device, such as a touchscreen panel 315, communicatively coupled to the controller 316. The input device permits an operator to provide inputs to the bagging machine 300 and can display information relating to the operating state of the bagging machine 300.

The controller 316 can include a central processing unit (CPU), a system bus, a memory connected to and accessible by other portions of controller through the system bus, a system interface, and hardware entities connected to system bus. The controller 316 can be connected to the input device, e.g., the touchscreen panel 315, and one or more output devices, via a wired (serial or Wired LAN) or wireless connection (e.g., a Bluetooth® connection or WiFi connection). The output devices can include, for example, one or more speakers, displays, etc. (not shown). The system interface is configured to facilitate wired or wireless communications to and from external devices, e.g., network nodes such as access points, etc.

At least some of the hardware entities perform actions involving access to and use of memory, which can be a random access memory (RAM), a disk driver, a compact disc read only memory (CD-ROM), or remote “cloud” based processing. The hardware entities can include a disk drive unit that includes a computer-readable storage medium on which is stored one or more sets of instructions, e.g., software code, configured to implement one or more of the methodologies, procedures, or functions described herein. The instructions also can reside, completely or at least partially, within the memory and/or within the CPU during execution thereof by the controller 316. The memory and the CPU also can constitute machine-readable media. The term “machine-readable media,” as used herein, refers to a single medium or multiple media (e.g., a centralized or distributed database, and/or associated caches and servers) that store the one or more sets of the instructions. The term “machine-readable media,” as used herein, also refers to any medium that is capable of storing, encoding or carrying a set of the instructions for execution by the controller 316 and that cause the controller to perform any one or more of the methodologies of the present disclosure. The above details of the controller 316 are presented for illustrative purposes only. The controller 316 can have other configurations in alternative embodiments.

The bagging machine 300 also includes a label maker 322 communicatively coupled to the controller 316 and configured to print a label 163, such as an address label, and to place the label 163 on an outer surface of the envelope 162.

Examples of bagging machines include those disclosed, for example, in U.S. Provisional Patent Application No. 63/857,449 filed on Aug. 4, 2025 and U.S. Provisional Patent Application No. 63/857,306 filed on Aug. 4, 2025. The contents of each of these applications are incorporated by reference herein in their entireties.

Additional examples of bagging machines include those disclosed, for example, in U.S. Pat. No. 12,421,001 issued Sep. 23, 2025, the contents of which are incorporated by reference herein in their entirety.

Referring to FIGS. 6-8 and 9-14, the splicing device 326 includes a backing member 328 having a support surface 329. The support surface 329 supports the web 104 and the web 106 during the splicing operation. The splicing device 326 also includes a restraining member 333 and a restraining member 334. The restraining member 333 is mounted on the backing member 328, proximate a downstream end thereof. The restraining member 334 is mounted on the backing member 328, proximate an upstream end thereof.

The splicing device 326 also includes a frame 330 on which the backing member 328 is mounted, and rollers or guides 331 mounted on the frame 330 upstream and downstream of the backing member 328. The splicing device 326 also can include sensors 332 configured to sense the edges of the sheet material being drawn over the splicing device 326. The sensors 332 also can detect the trailing end of the expiring roll 153 of sheet material as the roll 153 is about to expire.

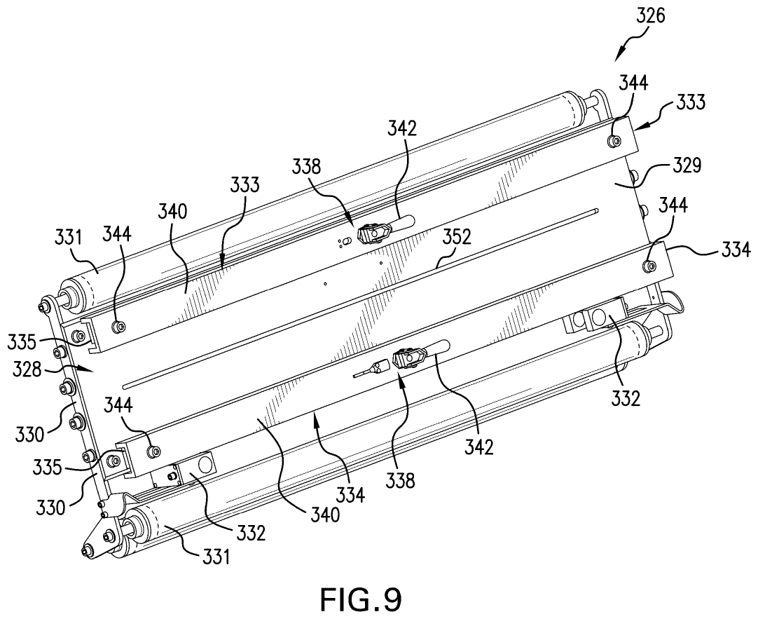

The restraining member 333 and the restraining member 334 are substantially identical, and the following description of the restraining member 333 applies equally to the restraining member 334. The restraining member 333 includes an elongated outer portion 340. The outer portion 340 can have a C-shaped cross section. The outer portion 340 is mounted on the support surface 329 of the backing member 228 via two cylindrical guides 343, shown in FIG. 9. The guides 343 are secured to the backing member 228 and the outer portion 340 be fasteners 344.

The restraining member 333 also includes a clamp bar 335 located within the outer portion 340. The clamp bar 335 engages the guides 343 via through holes formed in the clamp bar 335, and can move vertically within the outer portion 340 on the guides 343.

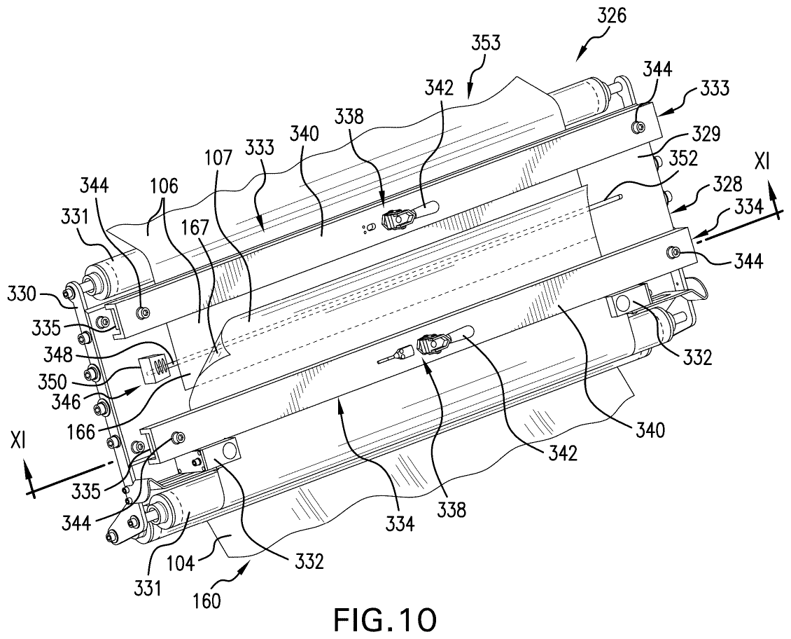

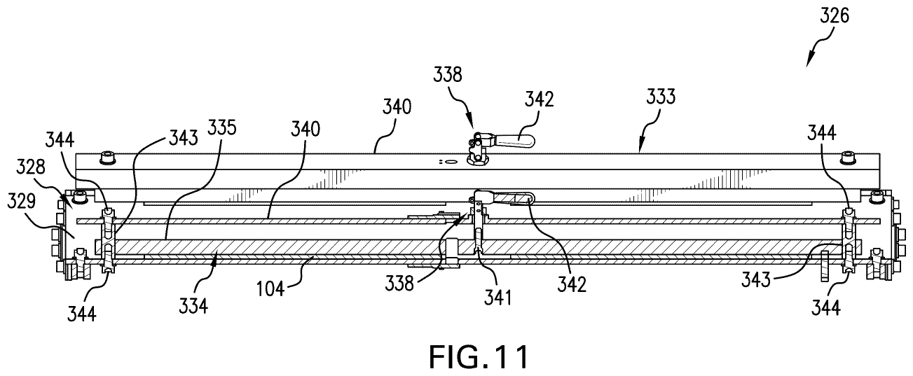

The restraining member 333 also includes a clamp 338. The clamp 338 is mounted on the outer portion 340 of the restraining member 333, proximate the lengthwise center point thereof. The clamp 338 engages the clamp bar 335 via a fastener 341 located at the approximate lengthwise center point of the clamp bar 335, as shown in FIG. 11. The clamp 338 has a handle 342 that is movable between a locking position, shown in FIGS. 10-14; and a release position, shown in FIG. 7 for the handle 342 of the restraining member 334. When the handle 342 is in the locking position, the clamp 338 urges the clamp bar 335 downward, so that the clamp bar 335 can restrain the web 106 of sheet material from the expiring roll 353 when the second web 106 is positioned between the clamp bar 335 and the support surface 329 of the backing member 328. When the handle 342 is moved to the release position, the clamp 338 urges the clamp bar 335 upward, releasing second web 106. The second restraining member 334 similarly can restrain and release the first web 104 of sheet material from the new roll 160, as depicted in FIG. 10. The restraining members 333,334 cooperate and act as restraints, configured to independently restrain portions of the web 104, 106 on the support surface 329.

The splicing device 326 also includes a cutting member 346, shown in FIGS. 10 and 12-14. The cutting member 346 is located between the restraining member 333 and the restraining member 334, and is configured to cut the web 104 of sheet material and the web 106 of sheet material when the web 104 and the web 106 have been placed on the support surface 329 of the backing member 228 in an overlapping relationship and the web 104 and the web 106 have been secured to the support surface 329 by the respective restraining member 334 and restraining member 333, as shown in FIG. 10.

The cutting member 346 includes a blade 348, and a grip 350 fixed to the blade 348. The backing member 228 has a slot 352 formed therein and extending inward from the support surface 329. The slot 352 is located between the restraining member 333 and the restraining member 334, and extends across the backing member 228 in a direction substantially parallel to the restraining member 333 and restraining member 334. In some embodiments, the cutting member 346 can include a cutter.

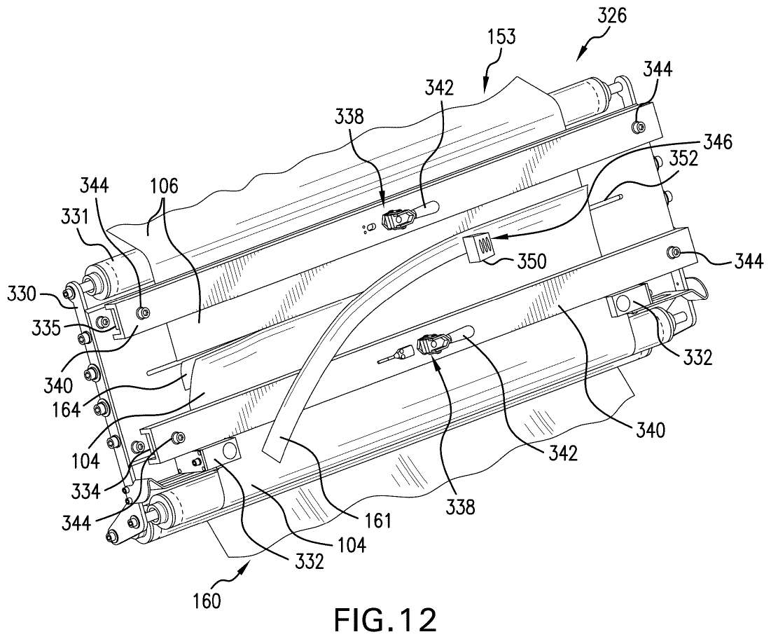

The slot 352 is configured to receive the blade 348. The grip 350 is configured to ride above the slot 352 and to slide over the overlapping portions of the web 104 and the web 106 as the cutting member 346 is moved across the backing member 228, with the cutting blade 348 severing the underlying portions of the web 104 and the web 106 as shown in FIG. 12.

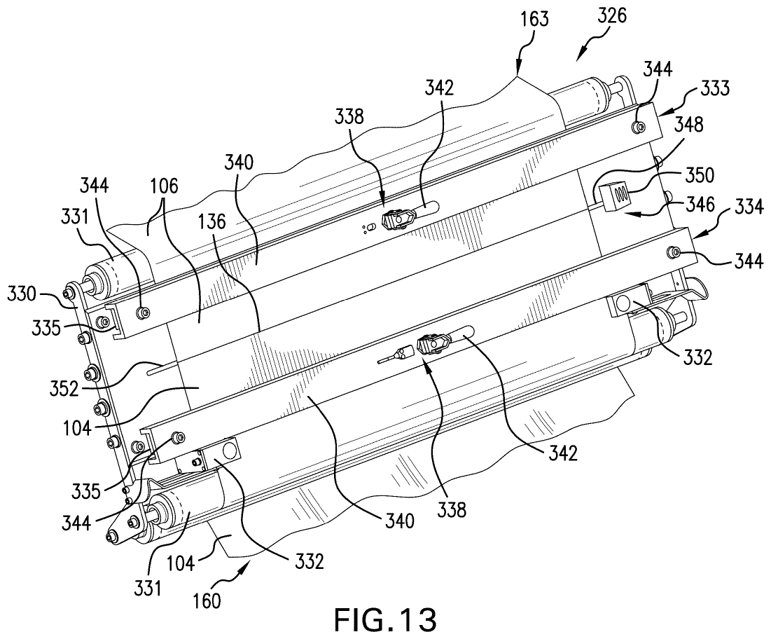

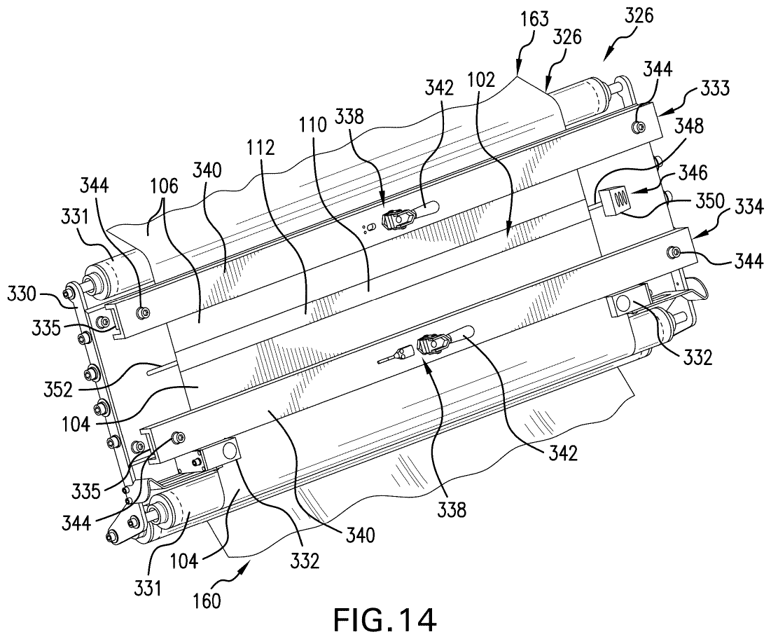

As discussed above, once the cut has been made in the web 104 and the web 106, the resulting remnant 161 of the web 106 and the remnant 164 of the web 106 can be removed. FIG. 13 depicts the web 104 and the web 106 after the remnants 161, 164 have been removed, with the newly-formed smooth, matched, and even edges at the interface 136 between the web 104 and web 106 visible in the figure. Splicing tape, e.g., the taping member 110 of the splicing tape 102, then can be placed across the newly-formed edges of the web 104 and the web 106 as shown in FIG. 14, to complete the splice between the expiring roll 353 and the new roll 160 to thereby form the spliced web 100. The handles 342 of the clamps 338 then can be moved to their respective release positions, to release the web 104 and the web 106.

Alternative embodiments of the splicing device 326 can be configured without the cutting member 346. In such embodiments, the user can utilize a small knife or other hand-held cutting instrument to cut through the overlapping portions 167, 166 of the webs 106, 104, using the slot 352 to guide the cutting instrument.

The use of the splicing device 326 with the bagging machine 300 is disclosed for illustrative purposes only. The splicing device 326 can be used with other types of bagging machines and automated baggers. Also, the splicing device 326 can be used with splicing tape other than the splicing tape 102.

The above descriptions of the bagging machine 300 and the envelopes 162 are presented for illustrative purposes only. The spliced web 100 formed by joining the first and second webs 104, 106 in the above manner can be processed on other types of automated machinery to produce other types of envelopes 162. For example, the spliced web 100 can be overlayed with another web 100, and the webs 100 can be joined by seals extending longitudinally along the side edges of webs 100 and transversely across the webs 100. The resulting double-walled web can be processed and separated into individual envelopes using suitable automated bagging equipment.

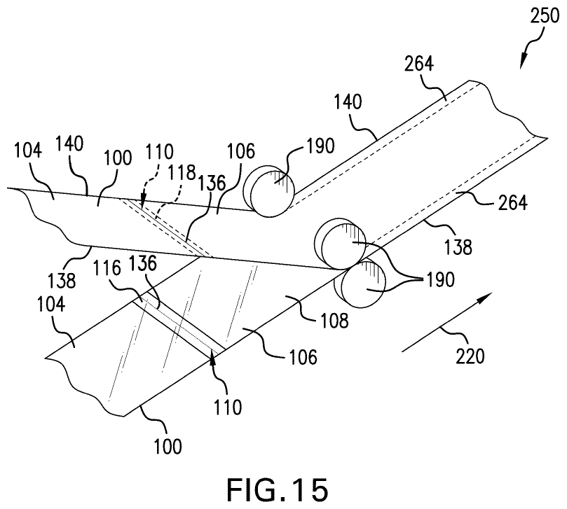

Referring to FIG. 15, two spliced webs 100 (or two webs 170) can be overlaid to form a formed web 250. Each of the spliced webs 100 can include the webs 104, 106 and the taping member 110. The taping member 110 can be applied at each interface 136 to connect the webs 104, 106. The heat-activatable material 108 on the webs 104, 106 and the heat-activatable material 116 can have substantially similar sealing conditions. Thus, the spliced webs 100 can each have an entirety of their respective sides 101 covered with the heat-activatable material 108 and the heat-activatable material 116. The webs 100 can therefore the edges 138, 140 be continuously sealed together at overlaying edge portions 150, 152.

A sealing mechanism can have sealing members, such as two pairs of heated rollers 190 to seal the overlapping edge portions 150, 152 along the edges 138, 140 and form a longitudinal seals 264 as the spliced webs 100 (or spliced webs 170) advances in the processing direction, denoted by arrow 220 in FIG. 15. The rollers 190 can apply heat to the overlapping edge portions 150, 152 (visible in FIG. 1). The heated rollers 190 can cause the heat-activatable material 108 of the webs 104, 106 and the heat-activatable material 116 of the taping member to reach their respective activation temperatures, thereby forming the bond. Because the taping member 110 includes heat-activatable material 116, the seals 264 can proceed as a continuous seal, even if one or more interfaces 136 is reached.

Transverse seals can be applied to the formed web 250 to form individual packaging containers and/or seal them closed The transverse seals can be formed at any desired location if the spliced webs 100 are used to form the formed web 250. The transverse seals can be formed at discrete locations of the heat-activatable material pattern if the spliced webs 170 are used to form the formed web 250. Splices at the interface 136 to connect webs 104, 106 will not interfere with sealing because sealing conditions, such as heating to an activation temperature, can be applied to the heat-activatable material 116 of the splicing tape 102 to form the bond. This arrangement can be advantageous for using a packaging machine, such as the bagging machine 400 (discussed below) to load and seal interconnected packaging containers, for example a fanfold supply of a web of envelopes.

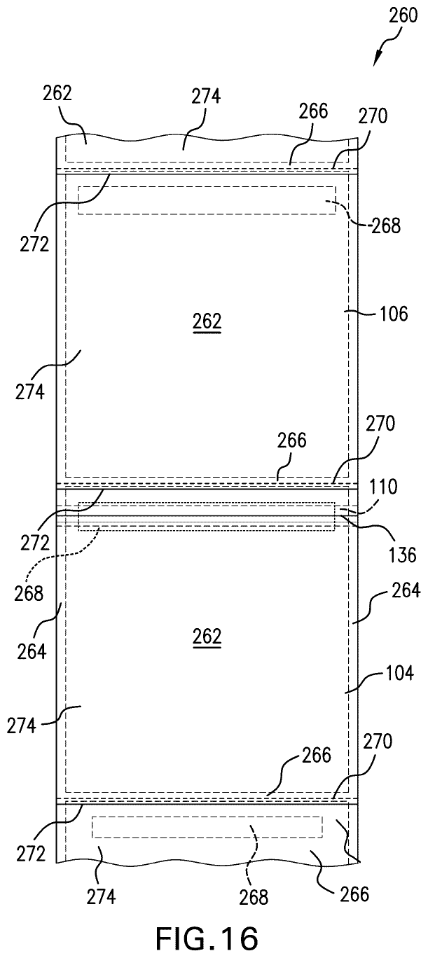

Referring to FIGS. 16-18, a bagging machine 400 facilitates the loading and sealing of preformed envelopes 262 (the bagging machine 400 is shown with certain elements removed for clarity). The envelopes 262 can be supplied to the bagging machine 400 as a continuous web 260 of interconnected envelopes 262. The envelopes 262 are configured to contain and hold an item 103 to be packaged, allowing the item 103 to be mailed or shipped.

Examples of bagging machines 400 suitable for use as the bagging machine 400 are disclosed, for example, in PCT Application No. PCT/US2025/043537, filed Aug. 26, 2025, the contents of which are incorporated by reference herein in their entirety.

The bagging machine 400 can be used with different types of flexible shipping containers such as envelopes having single ply walls or double-ply walls with, or without padding, insulating, and/or expandable material disposed between the plies of the walls. Alternative embodiments of the bagging machine 400 can be configured to receive and operate on an individual mailer or other individual shipping containers that are not connected to other similar mailers or other containers as in the continuous web 260.

The bagging machine 400 is configured to receive the web 260 of preformed envelopes 262; to form an opening in each envelope 262 to provide access an envelope pocket 261 defined by opposing walls 274, 276 of the envelope 262 so that the item 103 to be packaged can be loaded into the envelope pocket 261; to seal the loaded envelope 262; and to separate the sealed envelope 262 from the web 260.

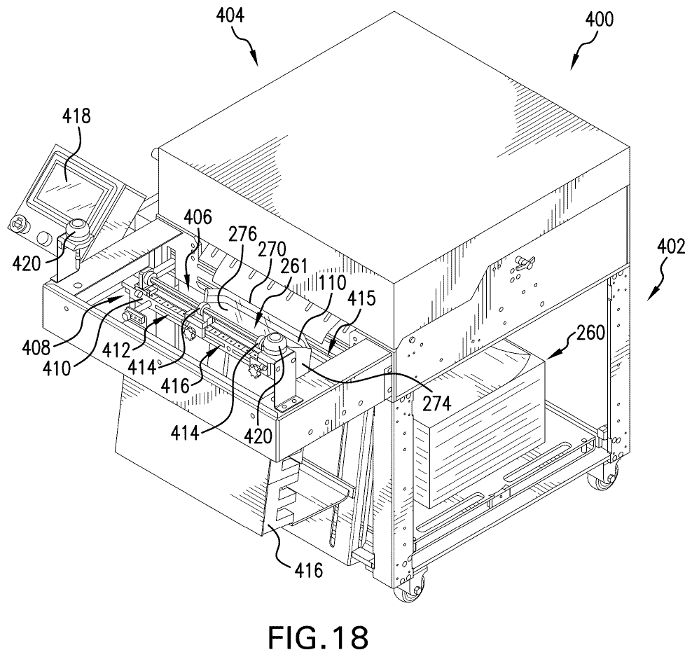

Referring to FIGS. 16-17 , the web 260 can be formed from two sheets of paper or other material joined along the respective side edge portions thereof by longitudinally extending inter-wall seals 264 shown in FIG. 16. The overlapping sheets form a front wall 274 and an opposing rear wall 276 of each envelope 262 as shown in FIG. 16 and FIG. 18, respectively. In alternative embodiments, the web 260 can be formed from a single sheet of C-folded material, with the overlapping side edge portions of the sheet fixed to each other by a single inter-wall seal 264. The web 260 can be formed, for example, from regular kraft paper. The web 260 can be formed from other types of paper including, for example, extensible paper; and from materials other than paper including, for example, polyethylene or other types of plastic film, in the alternative.

Referring to FIG. 16, a plurality of transversely extending inter-wall seals 266 are formed between the sheets of the web 260. Each inter-wall seal 266 corresponds to a bottom of a respective envelope 262.

Regions of weakness can be formed in the web 260, between each of the individual envelopes 262. The regions of weakness can be located adjacent to, and downstream of each inter-wall seal 266 on the web 260. The regions of weakness can be formed, for example, as a series of perforations 270 that extend transversely across the opposing front and rear walls 276, 276 of each envelope 262, between the inter-wall seals 264 of the web 260. The regions of weakness can be formed in other ways, such as a score line, in the alternative.

A cut 272 can be formed in the front wall 274 of each envelope 262. The cut 272 can be located adjacent to, and downstream of the series of perforations 270. The cut 272 can be spaced from the perforations 270 in the longitudinal direction of the web 260 by, for example, about ⅛ inch to about 3/16 inch. The cut 272 can be, for example, a kiss cut. The cut 272 permits the front wall 274 to be drawn away from the rear wall 276, to facilitate formation of the opening in the envelope 262. In alternative embodiments, the cut 272 and the perforations 270 can be formed at the same longitudinal location along the envelope 262 (in which case the front wall 274 would not include the perforations 270).

A sealing material in the form of a closure-sealing element 268 is disposed on an inwardly facing surface of the front wall 274 adjacent to, and downstream of the cut 272. The closure-sealing element 268 can be disposed on an inwardly facing surface of the rear wall 276 instead of, or in addition to, the front wall 274. The closure-sealing element 268 can be a heat-activatable material in the form of a heat sealable material or a hot-melt adhesive that, upon being heated and pressed, forms a closure seal 269 (visible in FIG. 17) that adheres the front wall 274 and the rear wall 276 of the envelope 262 to each other, thus maintaining the opening in a closed state. The closure sealing element 268 can be a pressure-sensitive adhesive, a cold glue, a cohesive material, or other type of material in the alternative. The closure sealing element 268 is depicted as being spaced from the adjacent portions of the inter-wall seals 264. The closure sealing element 268 can adjoin the inter-wall seals 264 in alternative embodiments of the envelope 262. In other alterative embodiments a flap can be formed, for example, by extending either the front wall 274 or the rear wall 276 and folding it over the opening. The closure seal 269 can affix the flap to the other of the front wall 274 and the rear wall 276.

Also, the closure seal 269, along with the and the inter-wall seals 264, 266, form a portion of a pocket border that completely circumscribes the envelope pocket 261 to retain the item 103 within the envelope pocket 261. Thus, prior to formation of the closure seal 269, the envelope pocket 261 is closed on three sides and open on the fourth side, with the fourth side being closed upon formation of the closure seal 269. The closure-sealing element 268 and the adjacent portions of the front wall 274 and the rear wall 276 define a sealing region on the envelope 262.

The above details of the envelope 262 are presented for illustrative purposes only. The bagging machine 400 can be used to load and seal other types of envelopes.

One or more spliced webs 100 can be subsequently formed into the web of envelopes 260. For example, one or more of the of the spliced webs 100 can be supplied to the bagging machine 400 to be formed into the web of envelopes 260. Each of the spliced webs 100 can include the webs 104, 106 and the taping member 110. The taping member 110 is applied at each interface 136 to connect the webs 104, 106. The heat-activatable material 108 on the webs 104, 106 and the heat-activatable material 116 can have substantially the same sealing conditions. Thus, the spliced webs 100 can each have an entirety of their respective sides 101 covered with the heat-activatable material 108 and the heat-activatable material 116 acting as a uniform heat-activatable layer. The spliced webs 100 therefore can be sealed at any location on the side 101. The various seals, for example, the inter-wall seals 264, 266 and the closure seal 269, can be applied at any location on the sides 101 regardless of the location where the webs 104, 106 may have been spliced together. The envelopes 262 thus can be continuously formed with minimal waste because there are no un-sealable regions to contend with. Additionally, because the taping member 110 includes the heat-activatable material 116, the taping member 110 can be positioned on the inside of the pocket 261. The aesthetic of the envelope is improved because the splicing is not visible on the exterior of the envelope 262.

The formed web 250 may be further formed into the web of envelopes 260, in the alternative. In other alternative embodiments, the web 170, the web 175, or the web 185 can be further formed into the web of envelopes 260. Because each of these formed webs 175, 185, 250 includes one or more spliced webs 100, an entirety of their respective sides 101 can be covered with the heat-activatable material 108 and the heat-activatable material 116 can act as a uniform heat-activatable layer. The spliced webs 100 can therefore be sealed at any location on the sides 101. The various seals, for example the inter-wall seals 266 and the closure seal 269 can be applied at any location on the sides 101 regardless of the location where the webs 104, 106 may have been spliced together. The inter-wall seal 264 is not necessary because the formed webs 175, 185, and 250 have been previously closed at the side edges 138, 140 during the forming operation.

In other alternative embodiments, the spliced web 170 can be used to form the web of envelopes 260. Additionally, or in the alternative, the spliced web 170 can be used to form the webs 175, 185, 250, any of which can be further formed to form the web of envelopes 260. When the spliced web 170 is used to form the web of envelopes 260, or when the webs 175, 185, 250 including the spliced web 170 are used to form the web of envelopes 260, the heat-activatable material 108 and the heat-activatable material 116 can form a pattern on the sides 101. As discussed above in relation to the spliced web 170 the pattern can correspond to a structural feature of an envelope 262, for example the height. Each of the spliced webs 170 can include the webs 104, 106 and the taping member 110. Because the taping member 110 includes the heat-activatable material 116, the taping member 110, once activated by sealing conditions, can similarly form seals on a packaging container, such as the envelope 262. The taping member 110 of the splicing tape 102 therefore can establish or continue the pattern of heat-activatable material 108 on the spliced web 170. Regardless of the location of a splice in the spliced web 170, the heat-activatable material 116 of the taping member 110 ensures that the spliced area is sealable.

Referring to FIGS. 16 and 17, the splice on the spliced web 100 can be present at random locations on the web of envelopes 260. Each of the spliced webs 100 includes the webs 104, 106 and the taping member 110. The taping member 110 includes the heat-activatable material 116 and is applied at each interface 136 to connect the webs 104, 106. The heat-activatable material 108 on the webs 104, 106 and the heat-activatable material 116 can have substantially the same sealing conditions. Thus, an entirety of the respective sides 101 of the spliced webs 100 can act as a uniform heat-activatable layer. The spliced webs 100 therefore can be sealed at any location on the side 101. The various seals, for example the inter-wall seals 264, 266 and the closure seal 269, can be applied at any location on the sides 101 regardless of the location at which the webs 104, 106 may have been spliced together. As shown in FIG. 16, the taping member 110 is positioned at the location of the sealing element 268. The taping member 110 is also on the inside of the pocket 261. In FIG. 16, the sealing element 118 of the taping member 110 is unsealed to allow access to the pocket 261 of the envelope 262 through the envelope opening. Upon the application of sealing conditions, however, the heat-activatable material will seal. For example, once the envelope 262 is loaded with an item, the bagging machine 400 may apply sealing conditions to the heat-activatable material 116, thereby forming the closure seal 269. FIG. 18 shows the web of envelopes 260 loaded in the bagging machine 400, with the taping member 110 aligned with the sealing mechanism 408 and pressure plate 416 of the bagging machine 400. Although the taping member 110 is disposed in the same location as the sealing element 268, the taping member 110 will not negatively interfere with sealing. Instead, the heat-activatable material 116 of the taping member 110 will form the closure seal 269 upon application of the sealing conditions.

As shown in FIG. 17, the taping member 110 is positioned at the pocket 261 of the envelope 262. The taping member 110 is also on the inside of the pocket 261. In FIG. 17, the sealing element 118 of the taping member 110 is sealed at has been sealed inter-wall seals 264. Although the taping member 110 was disposed in the same location as the inter-wall seals 264, the taping member 110 did not negatively interfere with sealing. Instead, the heat-activatable material 116 of the taping member 110 forms the inter-wall seal 264 upon application of the sealing conditions. The taping member 110 therefore does not interfere with sealing the envelope 262 or web of envelopes 260, regardless of the location of the splice and the taping member's location on the envelope 262.

Referring to FIG. 18, the bagging machine 400 is configured to operate in repetitive cycles in which the bagging machine 400 opens an envelope 262 to allow an item 103 to be placed inside the envelope pocket 261, closes the envelope 262, seals the envelope 262, separates the envelope 262 form the web 260, and advances another envelope 262 into position to repeat the cycle. The web 260 is fed into the bagging machine 400 via a bag handler 402. The bag handler may include a bag mover configured for moving the web 100 along the bagging machine 400.

A sealing cycle for an individual envelope 262 can begin after an operator (or a suitable automated device) has placed an item 103 in the pocket 261 of the envelope 262 by way of the envelope opening. The envelope 262 being loaded is located at the downstream end of the web 260 and is held open by grippers 414 of the bagging machine 400. The grippers 414 are mounted on a transverse member 410 of a sealing mechanism 408 of the bagging machine 400 and are rotatable in relation to the transverse member 410 between an open position and a gripping position.

The envelope opening had been formed at the conclusion of the previous sealing cycle by a suction cup (not shown), the grippers 414, and the transverse member 410, which had pulled the front wall 274 of the envelope 262 away from the rear wall 276 with the grippers 414 disposed in their gripping positions. The grippers 414 are rotatable on the shaft between their open and gripping positions.

At this point in the cycle, the envelope 262 to be loaded is located within an envelope-receiving space 406. The envelope-receiving space 406 is defined between a pressure plate 416 of the transverse member 410 and a sealing bar of the sealing mechanism 424 when the pressure plate 416 is spaced apart from the sealing bar 415. Alternatively, a single envelope 262, i.e., an envelope not part of a web 260, can be positioned in the envelope-receiving space 406 for loading and sealing as discussed below.

After the operator has placed the item 103 in the envelope pocket 261, the operator can commence the sealing cycle by pressing or otherwise activating an input device 420. In response, the controller 418 activates the bagging machine 400. Rearward movement of the transverse member 410 eventually causes the pressure plate 416 to push the front wall 274 of the envelope 262 into the rear wall 276 so that the closure-sealing element 268 becomes sandwiched between the front wall 274 and the rear wall 276, with the sealing bar 215 contacting the outward-facing surface of the rear wall 276 and resisting movement of the rear wall 276 in the rearward direction. As described above, FIG. 18 depicts the taping member 110 in the location of the closure-sealing element 268. The sealing sequence is substantially identical whether the taping member 110 or the seal-closure element 268 is aligned with the sealing bar 415.

As the pressure plate 416 approached the sealing bar 415 in the rearward direction, the grippers 414 rotated from the gripping position to the open position, which caused the grippers 414 to move out of the pocket 261 and out of contact with the front wall 274.

The bagging machine 400 is equipped with a foam pad 417 that is mounted on and moves with the transverse member 410 to compress or squeeze the envelope 262 and thereby drive air out of the envelope pocket 261 as the transverse member 410, including the attached pressure plate 416, moves rearward to close the envelope opening in preparation for the sealing process. Alternative embodiments of the bagging machine 400 can be equipped without the foam pad 417.

The sealing mechanism 408 also includes a heating element associated with the sealing bar 415. The heating element is configured to apply sealing conditions and form the closure seal 269 as the rear wall 276 is pushed into the sealing bar 215 by the pressure plate 416. As discussed above, the heating element can activate the heat-activatable material 116 of the taping member 110 or the seal-closure element 268. Alternative embodiments of the bagging machine can be equipped with seal flatteners.

After a predetermined dwell time sufficient to allow formation of the closure seal 269, the controller 418 activates a web advancement mechanism 404 of the bagging machine 400. The web advancement mechanism 404 pulls the web 260 in the upstream direction while the pressure plate 416 and the sealing bar 415 continue to grip the web 260, causing the perforations 270 between the newly-sealed envelope 262 and the adjacent envelope 262 to break, thereby separating the envelope 262 from the web 260. In alternative embodiments, the envelope 262 can be separated from the remainder of the web 260 using other techniques, such as one or more cutting edges configured to form a laceration along the region of weakness, the focused application of heat applied along the region of weakness, a heated wire, etc. In other alternative embodiments, the envelope 262 can be separated from the remainder of the web 260 on a manual basis.

Once the perforations 270 have been broken, the controller 418 deactivates the web advancement mechanism 404 causes the transverse member 410 (including the pressure plate 416) and the grippers 414 (still in their open position) to move in the forward direction, away from the sealing bar 415. The forward movement of the pressure plate 416 allows the envelope 262 to drop from the sealing mechanism 408. The controller 418 then activates the web advancement mechanism 404 to cause the web 260 to advance in the downstream direction until the closure-sealing element 268 of the next envelope 262 on the web 260 aligns with the pressure plate 416 and the sealing bar 415.

The controller 418 activates the transverse member in the rearward direction, toward the newly positioned envelope 262. The suction cup (not shown) mounted on the transverse member 410 contacts the front wall 274. The controller 418 activates the transverse member in the forward direction, away from the sealing bar 415, causing the front wall 274 to be drawn away from the rear wall 276 by the suction cup. Alternative embodiments of the bagging machine 400 can include an air blower configured to direct air onto the front wall 274 to aid in pre-forming the opening. As the transverse member 410 continues in the forward direction, the grippers 414 are rotated to their gripping position at which the grippers 414 contact the inwardly facing upper edge portion of the front wall 274 of the envelope 262. The controller 418 activates the pressure plate 416 to its open, or forward-most position. At this point, the sealing cycle has been completed and the newly-advanced envelope 262 is ready to be loaded and sealed during the next sealing cycle as discussed above.

In some embodiments the bagging machine includes additional features, for example seal flatteners or perforation breakers to facilitate the loading and sealing operations. Examples of bagging machines with additional features are disclosed, for example, in U.S. Application Publication No. US 2025/0128840 filed published Apr. 24, 2025, the contents of which are incorporated by reference herein in their entirety.

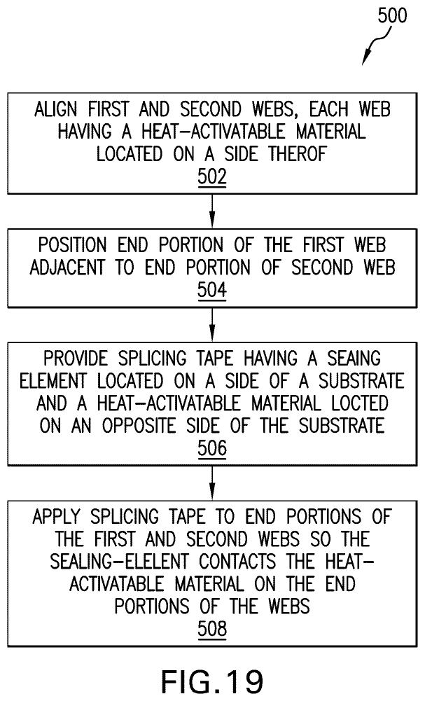

Referring to FIG. 19, a method 600 for forming a splice between the webs 104, 106 is shown. The following description of the method 500 is intended to be illustrative and not limiting or narrowing. The sides 101 of the webs 104, 106 can be align in a common orientation in activity 503. The webs 104, 106 each are formed of a piece of sheet material and each have the heat-activatable material 108 located on the respective sides 101. In activity 504, the end portion of web 104 can be positioned adjacent the end portion of the web 106. The splicing tape 102 is provided in activity 506. The splicing tape 102 including the substrate 114 with the heat-activatable material on the side 120 and the sealing element 118 on the side opposite side 122. The splicing tape 102 is applied to the respective end portions of the first and second webs 104, 106 in activity 508. The sealing element 118 is moved into contact with the heat-activatable material 108 on the sides 101 of the webs 104, 106.

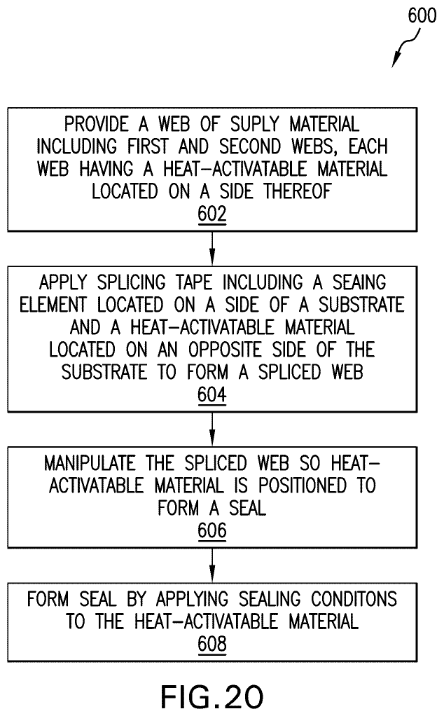

Referring to FIG. 20, a method 600 for forming the envelope 162, 262 is shown. The following description of the method 600 is intended to be illustrative and not limiting or narrowing. A web of supply is provided in activity 602. The web of supply material includes the webs 104, 106, each made of sheet material and each including the heat-activatable material 108 applies to the sides 101. The splicing tape 102 is applied in activity 604. The splicing tape 102 includes the heat-activatable material 116 located on the side 120 of the substrate 114 and the sealing element 118 located on the opposite side 122 of the substrate 114. The sealing element 118 can be applied to the sides 101 of the webs 104, 106 to form the spliced web 100. The sides 101 of the webs 104, 106 and the side 120 define the first side 101 of the spliced web 100. In activity 606, the spliced web 100 is manipulated so that the heat-activatable material is positioned to form a seal. In activity 608, the seal is formed by applying sealing conditions to at least one of the heat-activatable material 108 of the web 104, the heat-activatable material 108 of the web106, and the heat-activatable material of the sealing element 118. The sealing conditions include heating to an activation temperature sufficient to activate the heat-activatable material.

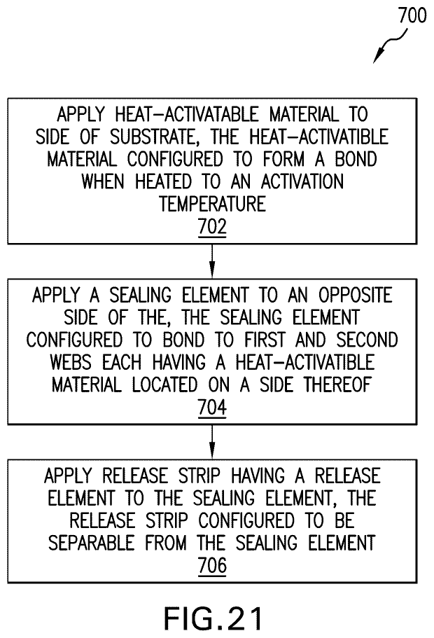

Referring to FIG. 21, a method 700 for manufacturing a splicing tape 102 is shown. The following description of the method 700 is intended to be illustrative and not limiting or narrowing. The heat-activatable material 116 is applied to the side 120 of the substrate 114 in activity 702. The heat-activatable material 116 can be configured to form a bond when heated to an activation temperature. In activity 704, the sealing element 118 is applied to the opposite side 122 of the substrate 114. The sealing element 118 can be configured to form a bond to the webs 104, 104. Each of the webs 104, 106 includes the heat-activatable material 108 located on a respective side 101. In some embodiments, the release strip 112 can be applied to the sealing element 118 in activity 706. The release strip 112 can include the release element 126. The release element 126 can be configured to lightly bond to the sealing element 118 so the release strip 112 is retained on the sealing element 18 and can be separated from the sealing element 118 while the sealing element 118 remains located on the substrate 114.

The splicing tape 102 can also be used in other packaging machines. For example, the splicing tape 102 can be used with dunnage machines. Examples of dunnage machines include those disclosed, for example, in U.S. Patent Application Publication No. US2025/0236087 published on Jul. 24, 2025, the contents of which are incorporated by reference herein in their entirety.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above-described embodiments. Rather, the scope of the present solution should be defined in accordance with the following claims and their equivalents.

What is claimed is:

1. A splicing tape configured to join a first and a second webs, the splicing tape comprising:
a first substrate having a first side and a second side, the first and second sides each defining an opposite major surfaces of the first substrate;
a first heat-activatable material located on the first side and configured to form a bond upon being heated to an activation temperature; and
a sealing element located on the second side and configured to affix the splicing tape to the first and second webs.

2. The splicing tape of claim 1, wherein the sealing element comprises an adhesive configured to form a bond with the first or second webs.

3. The splicing tape of claim 2, wherein the adhesive is a pressure-sensitive adhesive configured to form the bond upon application of a pressing force to the first side of the first substrate.

4. The splicing tape of claim 2, further comprising a release strip that includes:
a second substrate having a first side and a second side, the first and second sides of the second substrate each defining an opposite major surface of the second substrate; and
a release element located on the first side of the second substrate and configured to lightly bond to the adhesive so that the release strip covers and is retained on the adhesive and can be separated from the adhesive while the adhesive remains located on the first substrate.

5. The splicing tape of claim 4, wherein the release element is a coating comprising silicone applied to an entirety of the first side of the second substrate.

6. The splicing tape of claim 1, wherein:
the sealing element is configured to form a first bond upon application of a required first maximum temperature to the sealing element;
the heat-activatable material is configured to form a second bond upon application of a required second minimum temperature to the heat-activatable material; and
the heat-activatable material is configured to not form the second bond at the first maximum temperature.

7. The splicing tape of claim 1, wherein the heat-activatable material is a heat-sealable material.

8. The splicing tape of claim 1, wherein the heat-activatable material is a hot-melt adhesive.

9. The splicing tape of claim 1, further comprising a region of weakness extending transversely across the splicing tape at a predetermined location in a lengthwise direction of the splicing tape, the region of weakness facilitating separation of a first portion of the splicing tape at the predetermined location.

10. A spliced web, comprising:
the splicing tape of claim 1;
a first web made of a first sheet material and a second web made of a second sheet material, each web including a heat-activatable material located on a first side thereof, the heat-activatable material being configured to form a bond upon being heated to an activation temperature; and
the splicing tape is affixed to the first sides of the first and second webs by the sealing element so that the second web is connected to the first web by the splicing tape.

11. The spliced web of claim 10, wherein the first sides of the first and second web and the first side of the first substrate define a first side of the spliced web.

12. The spliced web of claim 11, wherein the heat-activatable material of the first and second webs and the heat-activatable material of the splicing tape cover at least 50% of the first side of the spliced web.

13. The spliced web of claim 11, wherein the heat-activatable material of the first and second webs and the heat-activatable material of the splicing tape extend continuously along the first side of the spliced web.

14. The spliced web of claim 10, wherein the heat-activatable material of the first and second webs is interrupted by regions of discontinuity.

15. The spliced web of claim 10, wherein the activation temperature of the heat-activatable material of the first and second webs is substantially identical to the activation temperature of the heat-activatable material of the splicing tape.

16. The splicing tape of claim 1, wherein:
the first web includes a first sheet substrate;
the second includes a second sheet substrate; and
at least one of the first sheet substrate, the second sheet substrate, and the first substrate is formed from paper.

17. A system, comprising:
a web of supply material including a first web made of a first sheet material and a second web made of a second sheet material, each web including a heat-activatable material located on a first side thereof, the heat-activatable material configured to form a bond upon being heating to an activation temperature;
the splicing tape of claim 1, the splicing tape configured to connect the first web to the second web by bonding to the first sides of the first and second webs, to form a spliced web that includes the splicing tape and the first and second webs; and
a packaging machine including a sealing mechanism having two opposing sealing surfaces configured to apply sealing conditions to a sealing area on the spliced web to form a seal.

18. The system of claim 17, wherein:
the packaging machine further comprises a folding apparatus configured to fold the spliced web about a fold line extending in a longitudinal direction of the spliced web so that a first portion of a first side of the spliced web overlies a second portion of the first side of the spliced web; and
the sealing mechanism is configured to apply the sealing conditions to form the seal between the first and second portions of the first side of the spliced web, in the sealing conditions including a sealing temperature sufficient to heat the heat-activatable material to the activation temperature.

19. The system of claim 18, wherein the sealing mechanism is configured to form the seal from the heat-activatable material on the splicing tape.

20. The system of claim 17, further comprising a splicing unit having a splicing support surface configured to support the first and second webs as the first and second webs are connected by the splicing tape.
